(19) United States
(12) Patent Application Publication
(10) Pub. No.: US 2026/0320147 A1
(43) Pub. Date: Oct. 15, 2026

(54) SIGNAL PROCESSING APPARATUS AND METHOD

(71) Applicant: NEC Corporation, Tokyo (JP)

(72) Inventor: Atsufumi SHIBAYAMA, Tokyo (JP)

(73) Assignee: NEC Corporation, Tokyo (JP)

(21) Appl. No.: 19/564,295

(22) Filed: Mar. 12, 2026

(30) Foreign Application Priority Data
Mar. 21, 2025 (JP) 2025-047442

(51) Int. Cl. G06F 17/14; G06F 7/523

(52) U.S. Cl. CPC G06F 17/142; G06F 7/523

(57) ABSTRACT

A signal processing apparatus includes a multiplication circuit configured to multiply data of D-bits (D≥3) in a second representation format by −1, wherein the second representation format, while for a non-negative data value being identical to a two's complement representation, for a negative data value, has a representation format in which (D−N−1) bits (N is a positive integer, N≤D−2) in the two's complement representation are bit-wise inverted, wherein the (D−N−1) bits are bits obtained by excluding MSB (most significant bit) and N consecutive lower bits including LSB (least significant bit), wherein the multiplication circuit includes a sign inversion circuit configured to bit-invert MSB of the data in the second representation format; and a −1 multiplication circuit to multiply the N consecutive lower bits including LSB of the data in the second representation format by −1.

### FIELD

The present disclosure is based upon and claims the benefit of the priority of Japanese patent application No. 2025-047442 filed on Mar. 21, 2025, the disclosure of which is incorporated herein in its entirety by reference thereto.

The present disclosure relates to a signal processing apparatus and method.

### BACKGROUND

In digital signal processing, a fast Fourier transform (FFT) is used as one of key processing. For example, a frequency-domain equalization (FDE) is known as a waveform distortion compensation technology to compensate a waveform distortion of a signal transmitted in wireless or wired communication.

In the frequency-domain equalization, first, a plurality of pieces of time-domain signal data are subjected to FFT processing to be transformed into a plurality of pieces of frequency-domain data, which are subjected to filtering for equalization. Then, a plurality of pieces of the filtered frequency-domain-data are subjected to inverse fast Fourier transform (IFFT) processing to be transformed into a plurality of pieces time-domain signal data, i.e., data with a waveform distortion in the original time-domain signal data compensated. It is noted that when there is no need to distinguish between FFT and IFFT, “FFT/IFFT” may be used.

Generally, “butterfly operation” is used in FFT/IFFT processing. For example, Reference Literature 1 discloses an FFT apparatus that employs a butterfly operation(s). Reference Literature 1 also discloses a twiddle factor operation(s) which will be described later, namely multiplication using a twiddle coefficient (a complex number, termed as twiddle operation coefficient or twiddle factor). Non-Patent Literature 1 discloses the Cooley-Tukey butterfly algorithm as an efficient FFT/IFFT processing. For example, Reference Literature 2 discloses a Prime Factor algorithm as one of efficient FFT/IFFT processing methods.

In addition, for example, Reference Literature 2 describes a Cooley-Tukey butterfly operation as an efficient FFT/IFFT processing method. The Cooley-Tukey FFT/IFFT with a large number of points, however, requires a complex circuit. Hence, FFT/IFFT processing is decomposed into two smaller FFTs/IFFTs by using a Prime Factor method described in Reference Literature 3, for example.

FIG. 26 illustrates data flow 500 of a 64-point FFT decomposed into a two-stage radix-8 butterfly process by using the Cooley-Tukey method. The data flow 500 includes a data reordering processing part 501, radix-8 butterfly operations performed a total of sixteen times by butterfly operation processing parts 502 and 503, and a twiddle factor multiplication processing part 504 that multiplies a twiddle factor {Wk} (W=exp(−2πj/N), j2=−1). (In FIG. 26, twiddle factors are (W0, W1, . . . , W7), . . . , (W0, W7, . . . , W49)). In the data flow 500 illustrated in FIG. 26, input time-domain data x(n) (n=0, 1, . . . , 63) is Fourier-transformed to frequency-domain signals X(k) (k=0, 1, . . . , 63) by the FFT processing. In FIG. 26, a part of the data flow is omitted. Even when performing IFFT processing, a basic structure of the data flow is the same as the data flow 500 illustrated in FIG. 26.

In a case where the number of FFT points is large, if the data flow 500 illustrated in FIG. 26 all is to be implemented by a circuit, the circuit would be of an enormous scale. Therefore, such an approach is generally adopted that the entirety of the FFT processing is implemented by repeatedly utilizing a circuit that implements a partial processing of a data flow according to a processing performance needed, in the case where the number of FFT points is large.

For example, in the data flow in FIG. 26, if an FFT apparatus that performs FFT processing on eight pieces of data in parallel (referred to as “in 8-data parallel” for short) is created as a physical circuit, 64-point FFT processing may be implemented by repeating the processing eight times in total.

Processing repeated eight times is performed sequentially, each corresponding to each of partial data flows 505a to 505h performed on eight pieces of data. More specifically, the processing is performed as follows:
at the first time, the processing corresponding to the partial data flow 505a is performed,
at the second time, the processing corresponding to the partial data flow 505b is performed,
at the third time, the processing corresponding to the partial data flow 505c (not shown in the drawing) is performed.
   Similarly, each of the processing up to the eighth partial data flow 505h is sequentially performed thereafter. The 64-point FFT processing is realized by the processing described above.

In a butterfly operation, a plurality of items of data arranged in a sequential order are read in an order according to a predetermined rule and processed. Therefore, the butterfly operation needs reordering of a plurality of items of data, for which a RAM (Random Access Memory) circuit(s) is/are mainly used. For example, Reference Literature 4 describes an FFT apparatus that performs reordering of a plurality of items of data using a RAM circuit(s) for a butterfly operation.

As a low power consumption technology, for example, Patent Literature 1 discloses a configuration that includes an operation processing part that performs operation processing, such as a butterfly operation, on data represented in a two's complement representation; and a storage processing part, such as RAM circuit, that performs storage processing on data represented in a sign magnitude—representation, which is a second representation format as a data representation format, wherein the sign magnitude—representation is identical to the two's complement representation when a data value is positive or zero, but all bits lower than the most significant bit indicating a sign in the two's complement representation are bit-wise inverted when the data value is negative.
[PTL 1]
International Publication Number WO 2019/131754 (Page 7, FIG. 1)

### SUMMARY

A two's complement representation is widely used as a representation scheme of signal data using binary number's digits in digital signal processing. In the two's complement representation, an addition/subtraction processing circuit may be implemented with a small circuit scale because the same circuit may be used to perform both addition and subtraction. On the other hand, a value per bit greatly differs between a small positive value and a small negative value in a vicinity of a value zero in the two's complement representation. As a result, if a signal taking a value which frequently changes between positive and negative in a vicinity of zero is to be represented by a two's complement, a bit-wise operation rate (toggle rate) would become large. Dynamic power dissipation (dynamic power dissipation) P of a digital signal processing circuit realized by a CMOS (Complementary Metal Oxide Semiconductor) circuit may be expressed by the following Equation (1):

P=(1/2)*a*C*V2*f (1)

where
a: circuit operation rate (percentage-activity),
C: load capacity,
V: voltage, and
f: operating frequency.
   A circuit operation rate (percentage-activity) is a ratio between an estimated value of the number of switching and the number of clock cycles during a certain period of time.

Since a bit-wise operation rate (toggle rate) of signal data determines the percentage-activity a, reduction of the bit-wise operation rate is effective for reduction of power dissipation (power dissipation). Signal data in signal processing for communication often changes between positive and negative in the vicinity of a value zero. In a fast Fourier transform (FFT) which is one of important processes in digital signal processing, internal data often takes a small value near a value zero.

When the two's complement representation is used in these processes, the bit-wise operation rate may become large, resulting in an increase of power dissipation.

To address this, there is a sign magnitude representation, as a representation scheme of digital data having a small bit-wise operation rate in a vicinity of the value zero. As an example of the two's complement representation and the sign magnitude representation, FIG. 27 shows binary representations of signal values of +15 to −16 in 5-bit signal data. In the two's complement representation, it is evident that bit values of higher-order bits differ significantly between positive and negative values, with the value zero as a boundary. Therefore, if a signal that frequently changes between positive and negative in the vicinity of the value zero is represented, the bit-wise operation rate will be large. For instance, when a signal value changes from +1 to −1, all seven bits other than the least significant bit (LSB) change.

Since the most significant bit (MSB) expresses a sign and other bits a magnitude of a value in the sign magnitude representation, the difference in bit values between positive and negative values, with the value zero as a boundary, is small. Hence, the bit-wise operation rate is small even when a signal that frequently changes between positive and negative in the vicinity of the value zero is represented. For example, when the signal value changes from +1 to −1, only one bit, the most significant bit, changes.

The sign magnitude representation, however, cannot represent a subtraction processing with an addition processing. Therefore, an addition processing circuit and a subtraction processing circuit must be separately prepared, which results in an increase of the scale of a circuit that implements the addition/subtraction processing. Since the circuit scale determines a load capacity C in the dynamic power dissipation P as given in Equation (1), an increase in the circuit scale increases a power dissipation.

That is, compared with the two's complement representation, the sign magnitude representation can reduce the percentage-activity a, but increases the load capacity C of an addition/subtraction circuit. This results in an issue of a large power dissipation for a signal processing including a significant amount of addition/subtraction processing, in particular.

It might be conceivable to use the two's complement representation which enables efficient circuit implementation for addition/subtraction processing and use the sign magnitude representation which enables reduction of an operation rate for processing other than addition/subtraction. However, conversion between the two's complement representation and the sign magnitude representation requires bit inversion and add-one processing (increment processing). In a case of a circuit requiring a lot of conversion processing, there is a problem that a power dissipation increases by that of the conversion circuit.

FIG. 28 illustrates a configuration example of a conversion circuit 600 that performs conversion between the two's complement representation and the sign magnitude representation. The conversion circuit 600 is configured by connecting a bit inversion circuit 601 and an add-one circuit 602. In the conversion circuit 600, the add-one circuit 602 in particular has a non-negligible circuit scale, compared with other logic processing circuits and operation processing circuits. Therefore, in a case where a lot of the conversion processing is required, there is a problem that the scale of the entire circuit and power dissipation increase by those of the conversion circuits.

Accordingly, the present disclosure has been devised in view of the problems described above, and it is an object thereof to provide a signal processing apparatus and method each enabling suppression or reduction of an increase in scale and power dissipation of an entire circuit.

According to an aspect of the present disclosure, a signal processing apparatus includes a first operation processing part configured to perform operation processing on data represented in a two's complement representation; a second operation processing part configured to include a multiplication process to multiply, by a multiplier of −1, data represented in a second representation format as a data representation format; and a storage processing part configured to perform storage processing on data represented in the second representation format, wherein the second representation format of the data of D-bits (where D is a positive integer greater than or equal to three), while for the data of a non-negative value being identical to the two's complement representation therefor, for the data of a negative value has a representation format in which (D−N−1) bits (where N is a positive integer such that N≤D−2) represented in the two's complement representation are bit-wise inverted, wherein the (D−N−1) bits are bits obtained by excluding, from the data of D-bits, a most significant bit indicating a sign and N consecutive lower bits including a least significant bit, and wherein the second operation processing part, as the multiplication process by the multiplier of −1, bit-inverts the most significant bit indicating the sign and multiplies the N consecutive lower bits including the least significant bit (where N is a positive integer such that N≤D−2) by −1 for the data of D-bits represented in the second representation format.

According to an aspect of the present disclosure, a signal processing apparatus constitutes a digital filter circuit and includes a first conversion part configured to convert a data representation format of a first complex-valued signal in frequency domain from a two's complement representation to a second representation format for output, the first complex-valued signal in frequency domain obtained by Fourier transform applied on a time-domain complex-valued signal received;
an IQ separator configured to separate the first complex-valued signal into a second complex-valued signal in frequency domain corresponding to a real part of the time-domain complex-valued signal, and a third complex-valued signal in frequency domain corresponding to an imaginary part of the time-domain complex-valued signal, and output the separated signals;
a first filter coefficient generation part configured to receive a first input filter coefficient and a third input filter coefficient and generate a first frequency-domain complex-valued filter coefficient using the first input filter coefficient and the third input filter coefficient;
a second filter coefficient generation part configured to receive a second input filter coefficient and the third input filter coefficient and generate a second frequency-domain complex-valued filter coefficient using the second input filter coefficient and the third input filter coefficient;
a first filter part configured to perform filter processing on the second complex-valued signal using the first frequency-domain filter coefficient to output a fourth complex-valued signal;
a second filter part configured to perform filter processing on the third complex-valued signal using the second frequency-domain filter coefficient to output a fifth complex-valued signal;
an IQ combiner configured to generate a sixth complex-valued signal by combining the fourth complex-valued signal and the fifth complex-valued signal.

The IQ separator includes a multiplication circuit to multiply, by a multiplier of −1, data of D-bits (where D is a positive integer greater than or equal to three) represented in the second representation format. The second representation format, while for a non-negative data value being identical to the two's complement representation therefor, for a negative data value, has a representation format in which (D−N−1) bits (where N is a positive integer such that N≤D−2) represented in the two's complement representation are bit-wise inverted, wherein the (D−N−1) bits are bits obtained by excluding, from the data of D-bits, a most significant bit indicating a sign and N consecutive lower bits including a least significant bit.

The multiplication circuit of the IQ separator, as multiplication by the multiplier of −1, bit-inverts the most significant bit indicating the sign and multiplies the N consecutive lower bits including the least significant bit (where N is a positive integer such that N≤D−2) by −1 for the data represented in the second representation format.

According to an aspect of the present disclosure, a signal processing method processes signal data represented in a second representation format as a data representation format, wherein the signal data is data of D-bits (where D is a positive integer greater than or equal to three), wherein the second representation format, while for a non-negative data value being identical to a two's complement representation therefor, for a negative data value has a representation format in which (D−N−1) bits (where N is a positive integer such that N≤D−2) represented in the two's complement representation are bit-wise inverted, wherein the (D−N−1) bits are bits obtained by excluding, from the data of D-bits, a most significant bit indicating a sign and N consecutive lower bits including a least significant bit, and wherein the N consecutive lower bits including the least significant bit represented in the second representation format are identical to the N consecutive lower bits including the least significant bit represented in the two's complement representation, and the signal processing method includes, when receiving the data represented in the second representation format and multiplying the data by −1, bit-inverting the most significant bit indicating the sign of the data represented in the second representation format; and multiplying the N consecutive lower bits including the least significant bit of the data represented in the second representation format (where N is a positive integer such that N≤D−2) by −1.

According to the present disclosure, it becomes possible to suppress or reduce an increase in circuit scale and power dissipation of a signal processing apparatus.

### BRIEF DESCRIPTION OF DRAWINGS

FIG. 1 is a diagram illustrating a configuration example of a signal processing apparatus relating to at least one of example embodiments of the present disclosure.

FIG. 2 is a diagram illustrating a configuration example of a storage processing part relating to at least one of example embodiments of the present disclosure.

FIG. 3 is a diagram illustrating an example of data representation formats relating to at least one of example embodiments of the present disclosure in a table format.

FIG. 4 is a diagram illustrating a configuration example of a conversion circuit relating to at least one of example embodiments of the present disclosure.

FIG. 5 is a diagram illustrating a configuration example of a storage processing part relating to at least one of example embodiments of the present disclosure.

FIG. 6 is a graph illustrating effects relating to at least one of example embodiments of the present disclosure.

FIG. 7 is a diagram illustrating a configuration example of an FFT apparatus relating to at least one of example embodiments of the present disclosure.

FIG. 8 is a diagram schematically illustrating data sets according to a sequential order in FFT processing relating to at least one of example embodiments of the present disclosure.

FIG. 9 is a diagram schematically illustrating data sets according to a bit-reversed order in the FFT processing relating to at least one of example embodiments of the present disclosure.

FIG. 10 is a diagram illustrating a configuration example of a butterfly operation processing part relating to at least one of example embodiments of the present disclosure.

FIG. 11 is a diagram illustrating a configuration example of a twiddle factor multiplication processing part relating to at least one of example embodiments of the present disclosure.

FIG. 12 is a diagram illustrating a configuration example of a data reordering processing part relating to at least one of example embodiments of the present disclosure.

FIG. 13 is a diagram illustrating a configuration example of a data reordering circuit relating to at least one of example embodiments of the present disclosure.

FIG. 14 is a timing diagram showing an example of an operation of the data reordering circuit relating to at least one of example embodiments of the present disclosure.

FIG. 15 is a diagram showing a state of RAM circuits 210a to 210h relating to at least one of example embodiments of the present disclosure.

FIG. 16 is a diagram showing a state of the RAM circuits 210a to 210h relating to at least one of example embodiments of the present disclosure.

FIG. 17 is a diagram illustrating a configuration example of a data reordering processing part relating to at least one of example embodiments of the present disclosure.

FIG. 18 is a diagram illustrating a configuration example of a digital filter circuit relating to at least one of example embodiments of the present disclosure.

FIG. 19 is a diagram illustrating a configuration example of an IQ separation circuit relating to at least one of example embodiments of the present disclosure.

FIG. 20 is a diagram illustrating a configuration example of a multiplication circuit relating to at least one of example embodiments of the present disclosure.

FIG. 21 is a diagram illustrating a configuration example of a filter circuit relating to at least one of example embodiments of the present disclosure.

FIG. 22 is a diagram illustrating a configuration example of a filter circuit relating to at least one of example embodiments of the present disclosure.

FIG. 23 is a diagram illustrating a configuration example of an IQ combining circuit relating to at least one of example embodiments of the present disclosure.

FIG. 24 is a diagram illustrating a configuration example of a filter coefficient generation circuit relating to at least one of example embodiments of the present disclosure.

FIG. 25 is a diagram illustrating a configuration example of a filter coefficient generation circuit relating to at least one of example embodiments of the present disclosure.

FIG. 26 is a diagram illustrating an example of a 64-point FFT data flow.

FIG. 27 is a diagram illustrating an example of data representation formats in a table format.

FIG. 28 is a block diagram illustrating a configuration example of a conversion circuit.

FIG. 29 is a block diagram illustrating a configuration example of a conversion circuit.

### EXAMPLE EMBODIMENTS

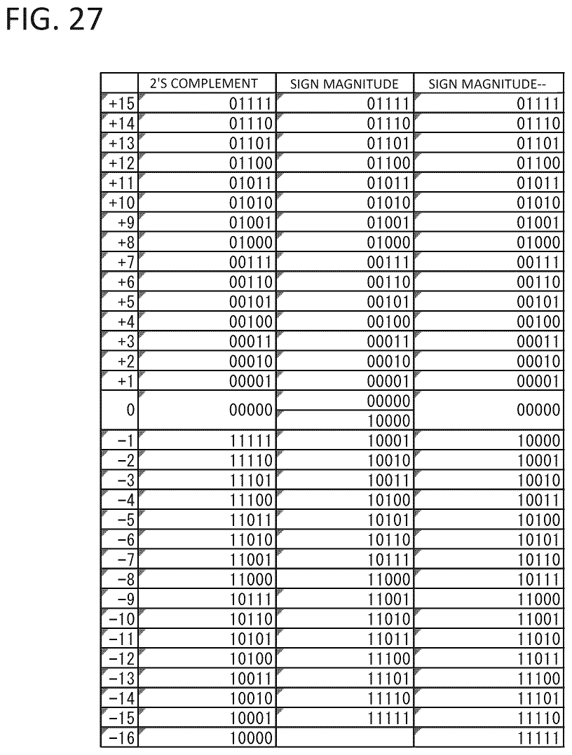

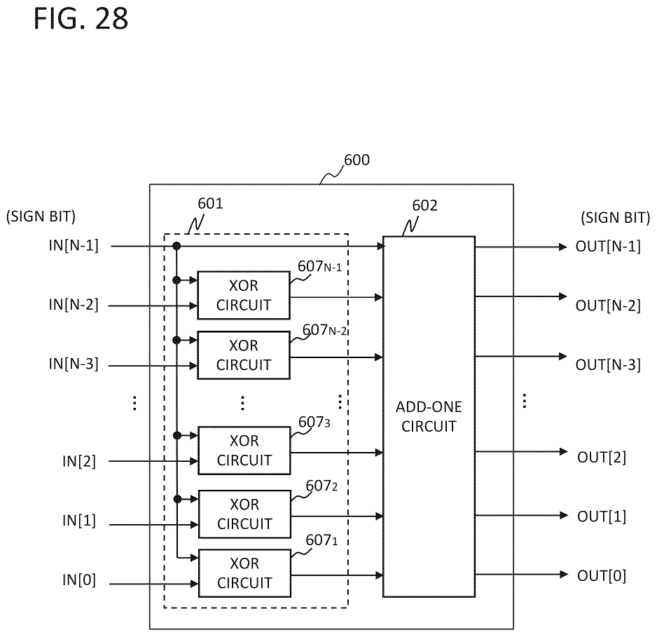

The following describes several example embodiments of the present disclosure. First, as a premise of the present disclosure, the following describes the “sign magnitude—representation” proposed in Patent Literature 1 as a data representation format for reduction of a circuit scale and power dissipation of the circuit of FIG. 28. As an example of the “sign magnitude—representation,” FIG. 27 shows binary representations of signal values of +15 to −16 in 5-bit signal data, in addition to those in the two's complement representation and the sign magnitude representation. The “sign magnitude—representation” is identical to the two's complement representation when a data value is positive or zero, but all bits other than the most significant bit indicating a sign in the two's complement representation are bit-wise inverted when the data value is negative. Since the “sign magnitude—representation” is a term used in Patent Literature 1 and not necessarily a commonly used technical term, it was written in quotation marks in the above. Hereinafter, however, it will be written without quotation marks.

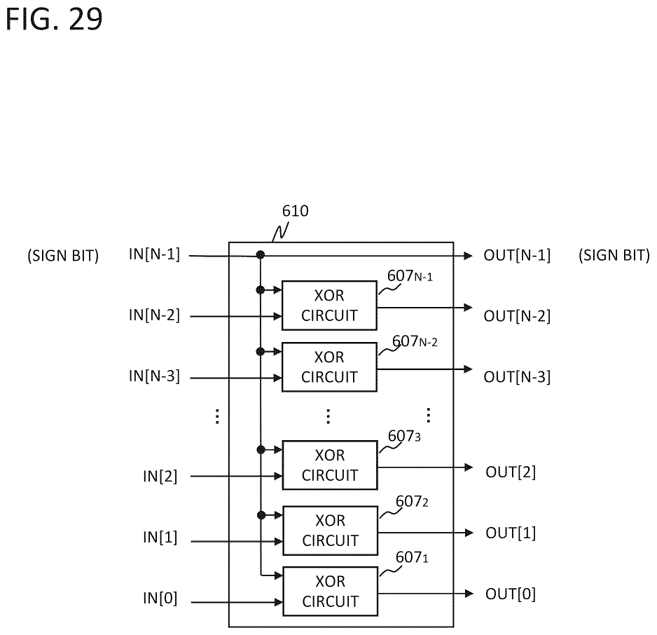

FIG. 29 illustrates a configuration example of a conversion circuit 610 that performs conversion between the two's complement representation and the sign magnitude—representation. A sign bit IN [N−1], the MSB (Most Significant Bit), is outputted as an output bit OUT[N−1], and outputs of XOR circuits 607₁ to 607_{N-1}, which receive the sign bit IN [N−1] and each bit IN [i] (i=0, . . . , N−2) as inputs, are output bits OUT [i] (i=0, . . . , N−2). Conversion between the two's complement representation and the sign magnitude—representation may be achieved only with bit inversion processing performed by the bit inversion circuit 601. Since this does not require add-one processing performed by the add-one circuit 602, which is required to perform conversion between the two's complement representation and the sign magnitude representation, a circuit scale and a power dissipation of the conversion circuit may be reduced.

However, even in a case where the sign magnitude—representation is used, if the number of conversion circuits is large, there is a problem that the overall circuit scale and power dissipation still increase.

The issue described above is merely one example; however, according to the present disclosure, it is possible to suppress or reduce an increase in circuit scale and power dissipation without being limited to the example described above.

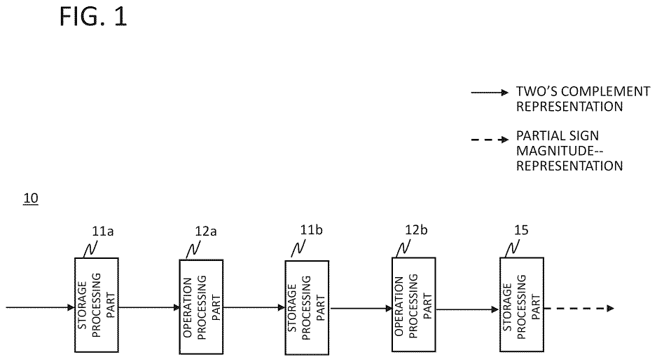

FIG. 1 is a diagram illustrating a configuration example of a signal processing apparatus 10 relating to at least one of example embodiments of the present disclosure. Referring to FIG. 1, the signal processing apparatus 10 includes storage processing parts 11a, 11b, and 15 that may perform storage processing such as buffering signal data, re-timing and reordering processing, and operation (arithmetic operation) processing parts 12a and 12b that may perform operation (arithmetic operation) processing such as addition/subtraction and multiplication/division. FIG. 1 illustrates a flow of data in processing (it is noted that signals between the parts are not always unidirectional). The storage processing parts 11a, 11b, etc., may be referred to as the storage processing parts 11 with the signs a, b, etc., omitted except when each part is specified in the description. The same applies to other elements.

The storage processing part 11a receives signal data represented in the two's complement representation from outside (not shown in the drawing) of the signal processing apparatus 10, performs storage processing, and outputs the result to the operation processing part 12a.

The operation processing part 12a receives the signal data represented in the two's complement representation from the storage processing part 11a, performs operation processing, and outputs a result to the storage processing part 11b.

The storage processing part 11b receives the signal data represented in the two's complement representation from the operation processing part 12a, performs storage processing, and outputs the result to the operation processing part 12b.

The operation processing part 12b receives the signal data represented in the two's complement representation from the storage processing part 11b, performs operation processing, and outputs a processing result to the storage processing part 15.

The storage processing part 15 receives the signal data represented in the two's complement representation from the operation processing part 12b, performs storage processing, and outputs signal data represented in “partial sign magnitude—representation” to the outside of the signal processing apparatus 10. It is noted that the “partial sign magnitude—representation” is a term that is used solely herein. The “partial sign magnitude—representation” is identical to the two's complement representation when a data value of D bits (D is a positive integer greater than or equal to three) is positive or zero, and all bits in the two's complement representation are bit-wise inverted except for the most significant bit indicating a sign and the consecutive lower N bits (N is a positive integer such that N≤D−2) including the least significant bit when a data value is negative.

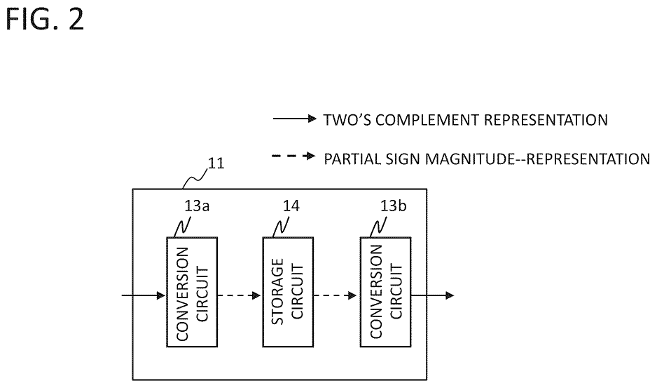

The storage processing parts 11a and 11b may be implemented by, for example, a storage processing part 11 illustrated in FIG. 2. Referring to FIG. 2, the storage processing part 11 includes a first conversion circuit 13a, a storage circuit 14, and a second conversion circuit 13b. The first conversion circuit 13a is configured to receive and convert signal data represented in the two's complement representation to signal data represented in the partial sign magnitude—representation, for output.

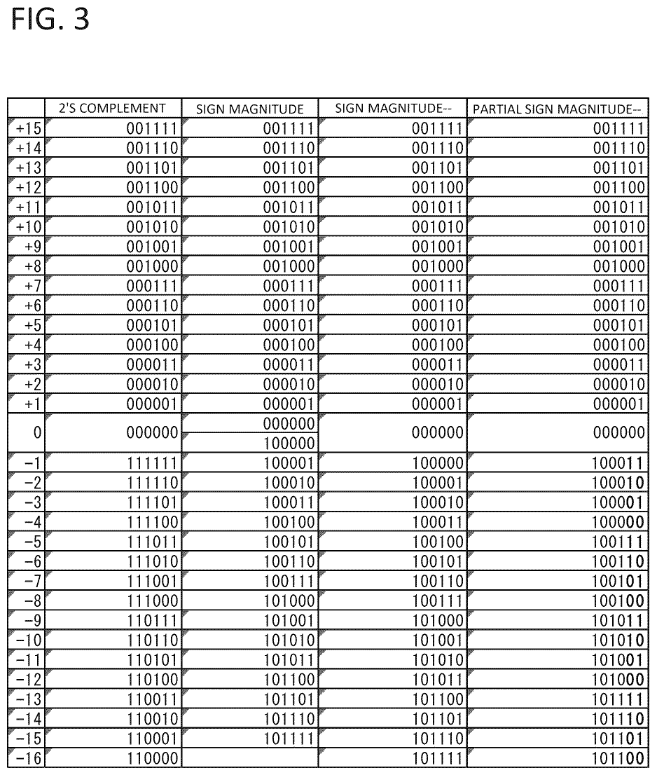

FIG. 3 illustrates the binary representations of +15 to −16 signal values in 6-bits signal data (the number of data bits D=6; the number of unconverted bits N=2) in the partial sign magnitude—representation and those in the two's complement representation, the sign magnitude representation, and the sign magnitude—representation as a comparison. In FIG. 3, positive data values are represented by the same bit values in the partial sign magnitude—representation, the two's complement representation, the sign magnitude representation, and the sign magnitude—representation.

The data value zero is represented by the same bit value in the partial sign magnitude—representation and the two's complement representation.

When a data value is negative, the partial sign magnitude—representation is obtained by inverting remaining three bits in the two's complement representation, after excluding the most significant bit indicating a sign and two lower bits including the least significant bit. Similarly, when a data value is negative, the two's complement representation is obtained by inverting the remaining three bits in the partial sign magnitude—representation, after excluding the most significant bit indicating a sign and the two lower bits including the least significant bit. Therefore, when a data value is negative, the difference between the partial sign magnitude—representation and the sign magnitude—representation is the two lower bits including the least significant bit.

As illustrated in FIG. 3, with the value zero as a boundary, the difference in bit values between positive and negative values is small in the partial sign magnitude—representation, as with the sign magnitude representation and the sign magnitude—representation. Therefore, when a signal whose value frequently changes between positive and negative in the vicinity of zero is represented, the bit-wise operation rate is small.

For instance, when a signal value changes from +1 to −1, since it changes from +1 (“000001”) to −1 (“100011”) in the partial sign magnitude—representation, a total of two bits changes: the most significant bit and the bit second to the least significant bit.

Since the signal value changes from +1 (“000001”) to −1 (“111111”) in the two's complement representation, a total of five bits other than the least significant bit changes. In the sign magnitude—representation, a change from +1 (“000001”) to −1 (“100000”) entails two changed bits in total: the most significant bit and the least significant bit.

Referring to FIG. 2 again, the storage circuit 14 is a circuit configured to receive signal data represented in the partial sign magnitude—representation outputted by the first conversion circuit 13a, and perform storage processing on the signal data while in the partial sign magnitude—representation to output the result to the second conversion circuit 13b in the partial sign magnitude—representation.

The second conversion circuit 13b is a circuit configured to convert the signal data represented in the partial sign magnitude—representation and outputted by the storage circuit 14 to signal data represented in the two's complement representation, and output the result.

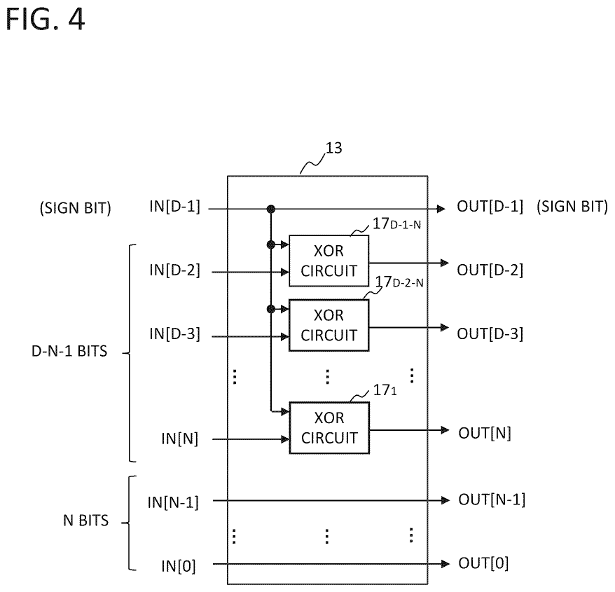

The first and the second conversion circuits 13a and 13b are configured identically and may be implemented by a conversion circuit 13 illustrated in FIG. 4 for example. Referring to FIG. 4, the conversion circuit 13 is a circuit configured to receive in parallel D-bits (D is a positive integer greater than or equal to three) signal data (IN[0] to IN[D−1]) in the two's complement representation, convert the two's complement representation to the partial sign magnitude—representation, and output the resultant data of D-bits (OUT[0] to OUT[D−1]) in parallel.

Further, the conversion circuit 13 is a circuit configured to receive in parallel D-bits signal data (IN[0] to IN[D−1]) in the partial sign magnitude—representation, convert the partial sign magnitude—representation to the two's complement representation, and output the resultant data of D-bits (OUT[0] to OUT[D−1]) in parallel.

The conversion circuit 13 is configured to receive the most significant bit indicating a sign from the input IN[D−1] and output as it is to OUT[D−1] as a sign bit.

The conversion circuit 13 is configured to output consecutive lower N bits including the least significant bit received from the inputs IN[0] to IN [N−1], as they are, to the outputs OUT[0] to OUT[N−1], respectively.

The conversion circuit 13 is configured to supply other bits received from the inputs IN[N] to IN[D−2] to respective XOR (Exclusive OR) circuits 17, and outputs results of XORs between the most significant bit indicating a sign received from the input IN[D−1] and respective ones of the bits supplied to the XOR (Exclusive OR) circuits 17 to the outputs OUT [N] to OUT[D−2], respectively.

Therefore, when an input data value is positive or zero, the value of the most significant bit indicating a sign received from the input IN[D−1] is zero, and the bit values supplied to the inputs IN[0] to IN[D−2] are outputted as they are to the outputs OUT[0] to OUT[D−2], respectively.

Conversely, when an input data value is negative, the value of the most significant bit received from the input IN[D−1] and indicating a sign is one, and the data values supplied to the inputs IN[0] to IN [N−1] are outputted as they are to the outputs OUT[0] to OUT[N−1], respectively. Data obtained by inverting the respective data values supplied to the inputs IN[N] to IN[D−2] using exclusive OR operations are outputted to the outputs OUT [N] to OUT[D−2], respectively.

In the processing described above, the conversion circuit 13 converts the two's complement representation to the partial sign magnitude—representation and convert the partial sign magnitude—representation to the two's complement representation.

As described above, the conversion circuit 13 achieves conversion between the two's complement representation and the partial sign magnitude—representation only with bit inversion processing and does not require add-one processing, which is required for the sign magnitude representation. Since bit inversion may be implemented with exclusive OR operation (XOR circuit), this may be implemented with an overwhelmingly small circuit scale, as compared with other logic processing circuits and operation processing circuits.

As compared with conversion between the two's complement representation and the sign magnitude—representation, the number of required XOR circuits 17 is smaller, and the scale of the conversion circuit 13 may be reduced accordingly.

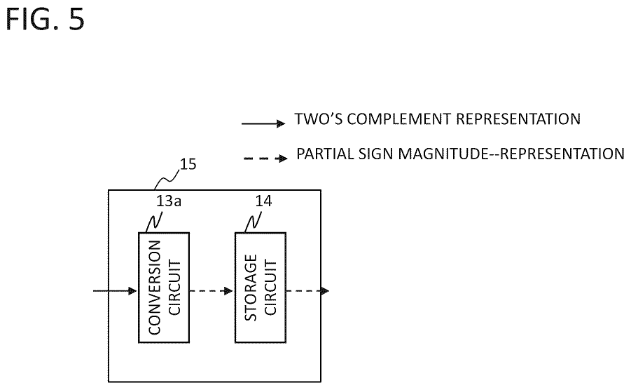

Next, with reference to FIG. 5, the storage processing part 15 includes a first conversion circuit 13a and a storage circuit 14. The storage processing part 15 receives signal data represented in the two's complement representation, and performs storage processing on the signal data represented in the partial sign magnitude—representation to output a result represented in the partial sign magnitude—representation. More specifically, the conversion circuit 13a is configured to receive and convert signal data represented in the two's complement representation to signal data represented in the partial sign magnitude—representation for output. The storage circuit 14 is configured to receive signal data represented in the partial sign magnitude—representation outputted by the conversion circuit 13a, and perform storage processing on the signal data in the partial sign magnitude—representation to output the result while in the partial sign magnitude—representation. Therefore, the signal processing apparatus 10 performs signal processing on the signal data represented in the two's complement representation and outputs a result as signal data represented in the partial sign magnitude—representation.

As described above, in the storage processing parts 11a and 11b, the signal processing apparatus 10 is configured to convert data represented in the two's complement representation to data in the partial sign magnitude—representation, perform storage processing thereon, and then convert the data back to the two's complement representation in the present example embodiment. Further, in the storage processing part 15, the signal processing apparatus 10 is configured to convert data represented in the two's complement representation to data in the partial sign magnitude—representation, perform storage processing thereon, and output the result as signal data represented in the partial sign magnitude—representation.

As illustrated in FIG. 3, with the value zero as a boundary, the difference in bit values between positive and negative values is small in the partial sign magnitude—representation, as with the sign magnitude representation. Therefore, when a signal whose value frequently changes between positive and negative in the vicinity of zero is represented in the partial sign magnitude—representation, the bit-wise operation rate is small. As a result, the percentage-activity of the storage processing parts 11a, 11b, and 15, in each of which the signal data is represented in the partial sign magnitude—representation, may be reduced, compared with a case where the processing is performed without converting the two's complement representation.

The conversion circuit 13 performs conversion between the two's complement representation and the partial sign magnitude—representation only with bit inversion processing and does not require add-one processing (increment processing), which is required when using the sign magnitude representation. Bit inversion may be achieved only with an XOR circuit. Therefore, this may be implemented with an overwhelmingly small circuit scale, as compared with other logic processing circuits and operation processing circuits. As compared with conversion between the two's complement representation and the sign magnitude—representation, the number of required XOR circuits 17 is smaller, and the scale of the conversion circuit 13 may be reduced accordingly.

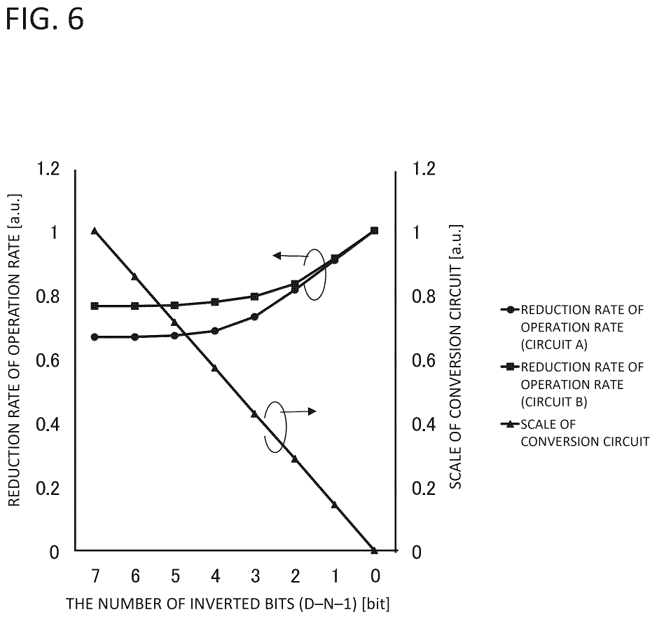

FIG. 6 is a graph illustrating effects of the partial sign magnitude—representation being applied to two example circuits, a circuit A and a circuit B, as a storage processing part in an FFT processing circuit, in which a bit width of signal data is eight bits (D=8). A horizontal axis in FIG. 6 is the number of inverted bits (D−N−1) in conversion processing between the two's complement representation and the partial sign magnitude—representation. When the number of inverted bits (D−N−1) is zero, there is no inverted bit, and the partial sign magnitude—representation is the same as the two's complement representation. When the number of inverted bits (D−N−1) is seven, i.e., N=0, since all the bits except for the sign bit, are bit-wise inverted, this is the same as the sign magnitude—representation. A case where the number of inverted bits is one to six corresponds to the partial sign magnitude—representation. The left vertical axis is a reduction rate of the bit-wise operation rate which indicates a relative value based on the operation rate in the two's complement representation. The right vertical axis is a scale of the conversion circuit which indicates a relative value based on the scale of the conversion circuit in the sign magnitude—representation.

Referring to FIG. 6, for example, in a case where the number of inverted bits is four, the bit-wise operation rates of the circuits A and B in the partial sign magnitude—representation are reduced to 20 to 30 percent of those in a case where the two's complement representation is used. This is the same reduction rate as when the sign magnitude—representation is used. The circuit scale is reduced to 40 percent as compared with a case where the sign magnitude—representation is used. That is, according to the present example embodiment, with a conversion circuit smaller than that in the sign magnitude—representation, the bit-wise operation rate may be reduced to the same extent as the sign magnitude—representation.

Therefore, in the present example embodiment, even when processing a signal with a value which frequently changes between positive and negative in the vicinity of zero, it is possible to keep the operation rate in the storage processing parts 11a, 11b, and 15 small. As a result, the power dissipation in the storage processing parts 11a, 11b, and 15 may be reduced.

In the present example embodiment, the operation processing parts 12a and 12b perform operation processing on the signal data in the two's complement representation. Therefore, the percentage-activity related to operation processing is not reduced. However, unlike in the conventional case where the sign magnitude representation is applied, conversion between data representation formats is not accompanied by increase the circuit scale. Therefore, the power dissipation of the entire signal processing apparatus may be reduced by a reduction amount of power dissipation in the storage processing parts 11a, 11b, and 15.

Although the storage processing parts 11a, 11b, and 15 perform storage processing such as buffering, re-timing, and rearranging signal data in the partial sign magnitude—representation and the operation processing parts 12a and 12b perform operation processing such as addition/subtraction and multiplication/division in the two's complement representation in the present example embodiment, the storage processing parts 11a, 11b, and 15 may perform operation processing such as addition/subtraction and multiplication/division based on the partial sign magnitude—representation if a desired result may be obtained from the processing in the partial sign magnitude—representation, in addition to the storage processing.

The following describes another example embodiment of the present disclosure. In this example embodiment, the present disclosure is applied to an FFT apparatus. The FFT apparatus includes a butterfly operation processing part configured to perform butterfly operation processing, a twiddle factor multiplication processing part configured to perform twiddle factor multiplication, and a data reordering processing part configured to rearrange an order of a plurality of pieces of data. The butterfly operation processing part and the twiddle factor multiplication processing part are configured to process data of D-bits (D is a positive integer greater than or equal to three) represented in the two's complement representation, and the data reordering processing part is configured to perform storage processing on data of D-bits represented in the partial sign magnitude—representation.

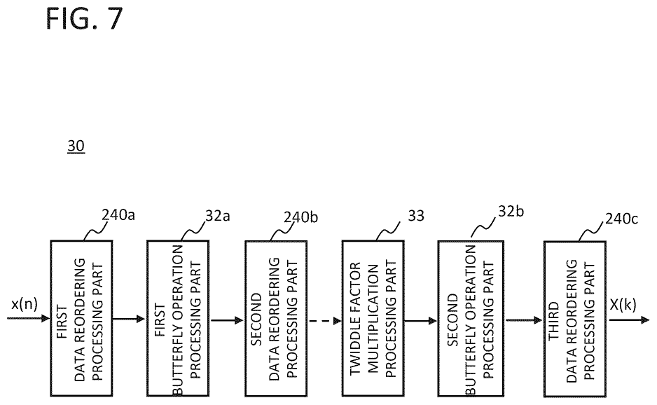

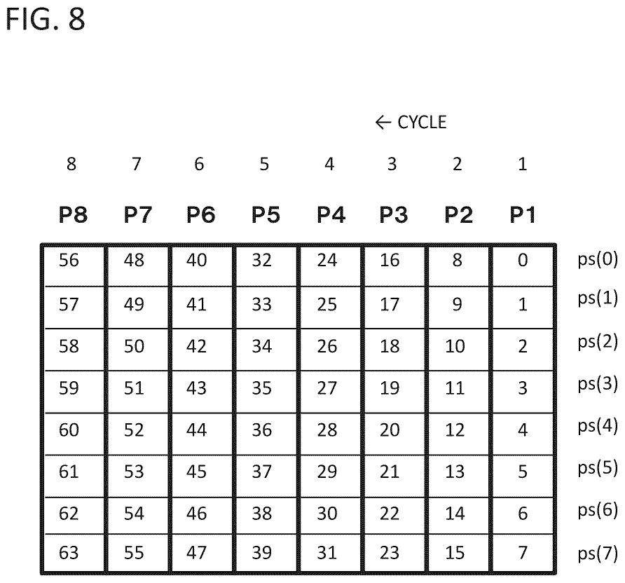

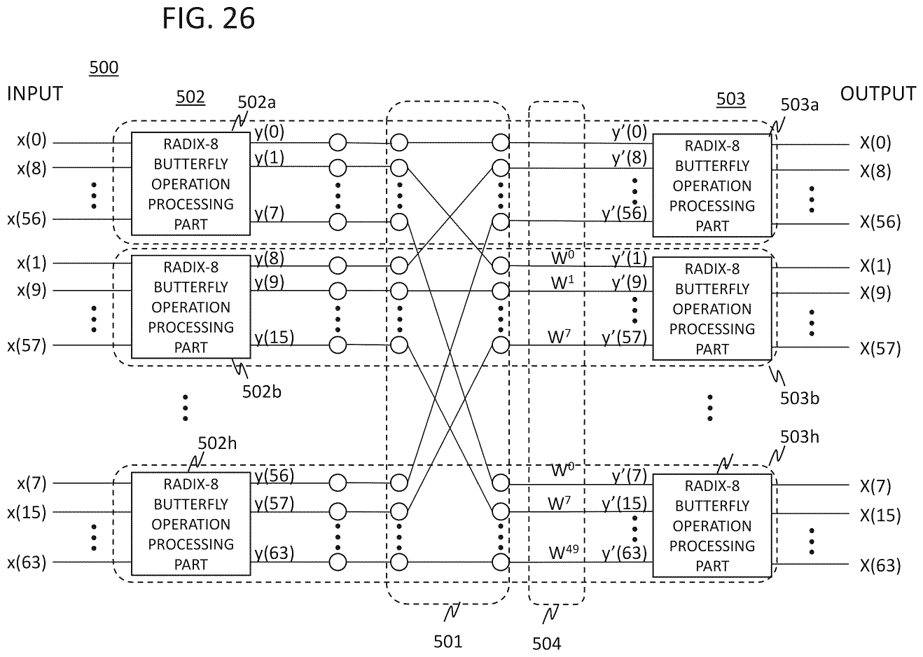

FIG. 7 is a block diagram illustrating a configuration example of the FFT apparatus 30 relating to the present example embodiment. The FFT apparatus 30 processes 64-point FFT decomposed into two-stages of radix-8 butterfly processing, using a pipeline circuit scheme, according to the data flow 500 illustrated in FIG. 26. The FFT apparatus 30 receives time-domain data x(n) (n=0, 1, . . . , N−1), performs Fourier-transformation on x(n) using FFT processing, and generates and outputs frequency-domain signals X(k) (k=0, 1, . . . , N−1). Here, N is a positive integer representing a FFT block size. It is assumed that the FFT apparatus 30 performs a 64-point FFT process in 8-data parallel (N=64), as a non-limiting example. In this case, the FFT apparatus 30 receives the time-domain data x(n) and generates and outputs the frequency-domain signals X(k), which have been Fourier-transformed using FFT processing. 64 pieces of data in total, eight pieces at a time in eight cycles, are inputted as the input data x(n) in the order as illustrated in FIG. 8. The numbers from 0 to 63 (eight rows×eight columns of elements) shown in a table in FIG. 8 represent an index n of x(n).

More specifically, in the first cycle, eight pieces of data x(0), x(1), . . . , and x(7) constituting a data set P1 are inputted.

Then, eight pieces of data x(8), x(9), . . . , and x(15) constituting a data set P2 are inputted in the second cycle. Similarly, in each cycle from the third to the eighth, data constituting data sets P3 to P8 are inputted thereafter, respectively.

Likewise, 64 pieces of data, eight pieces of data at a time in eight cycles, are outputted as output data X(k) in the order illustrated in FIG. 8. Note that the numbers from 0 to 63 shown in the table in FIG. 8 represent an index k of X(k).

More specifically, in the first cycle, eight pieces of data x(0), x(1), . . . , and x(7) constituting the data set P1 are outputted.

Eight pieces of data x(8), x(9), . . . , and x(15) constituting the data set P2 are outputted in the second cycle. Similarly, in each cycle from the third to the eighth, data constituting the data sets P3 to P8 are outputted thereafter, respectively.

As illustrated in FIG. 7, the FFT apparatus 30 includes a first data reordering processing part 240a, a first butterfly operation processing part 32a, a second data reordering processing part 240b, a twiddle factor multiplication processing part 33, a second butterfly operation processing part 32b, and a third data reordering processing part 250c.

The FFT apparatus 30 performs first data reordering processing, first butterfly operation processing, second data reordering processing, twiddle factor multiplication processing, second butterfly operation processing, and third data reordering processing, in pipeline processing.

The first data reordering processing part 240a and the second data reordering processing part 240b include buffer circuits to rearrange data. The first data reordering processing part 240a and the second data reordering processing part 240b rearrange a data sequence before and after the first butterfly operation processing part 32a, respectively, based on data dependency in an FFT processing algorithm.

Likewise, the third data reordering processing part 250c is a buffer circuit to rearrange data. That is, the third data reordering processing part 250c rearranges a data sequence after the second butterfly operation processing part 32b based on the data dependency in the algorithm of the FFT processing.

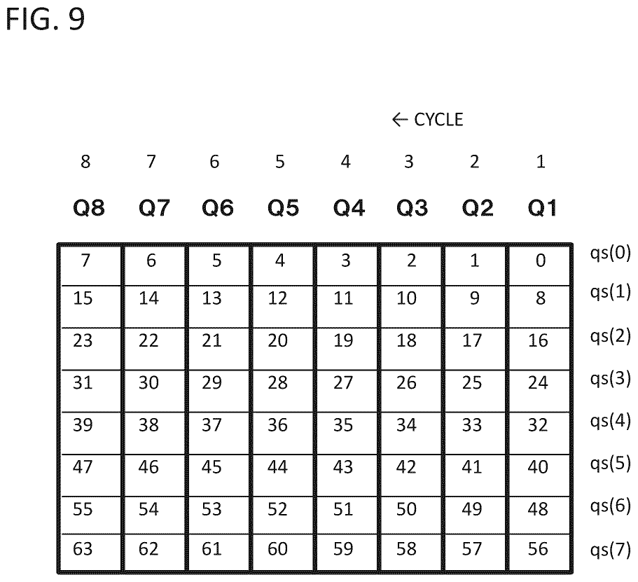

More specifically, the first data reordering processing part 240a rearranges a “sequential order” as illustrated in FIG. 8, which is an input order of the input data x(n), to a “bit-reversed order” as illustrated in FIG. 9, which corresponds to an order with which data is supplied to the first butterfly operation processing part 32a.

The bit-reversed order illustrated in FIG. 9 corresponds to input data sets supplied to the radix-8 butterfly operation processing part 502 in the first stage in the data flow diagram illustrated in FIG. 26.

More specifically, in a first cycle, eight pieces of data x(0), x(8), . . . , and x(56) constituting a data set Q1 are inputted. Then, eight pieces of data x(1), x(9), . . . , and x(57) constituting a data set Q2 are inputted in a second cycle. Similarly, in each cycle from a third to an eighth, data constituting data sets Q3 to Q8 are inputted thereafter, respectively.

A sequential order is an order of eight data sets P1, P2, P3, P4, P5, P6, P7, and P8 as illustrated in FIG. 8. A data set Ps (where s is a value representing an order of a processing cycle; s=1, 2, . . . , 8) is constituted by eight pieces of data sequentially arranged from ps(0) to ps(7). Assuming that x(0) to x(63), 64 pieces of data in total, every eight pieces in each cycle (total, eight cycles), are inputted in parallel in the order illustrated in FIG. 8, ps(i) (s, i=0, . . . , 7) is given as follows:

ps(i)=x[8×(s−1)+i]

The data sets are arranged in the order of P1, P2, P3, P4, P5, P6, P7, and P8 corresponding to the progress of the processing cycles. In the sequential order, s sets of data, in which i*s pieces of data are arranged from the first data to the last, by every i pieces of data, in the order of data are arranged in the order of cycles.

A bit-reversed order is an order of the eight data sets Q1, Q2, Q3, Q4, Q5, Q6, Q7, and Q8 illustrated in FIG. 9. A data set Qs (where s is a value representing an order of a processing cycle; s=1, 2, . . . , 8) is constituted by eight pieces of data sequentially arranged from qs(0) to qs(7). For 64 pieces of data x(0) to x(63) supplied in the sequential order, qs(i) (s, i=0, . . . , 7) is given as follows:

qs(i)=x[(s−1)+8×i]

The data sets are arranged in the order of Q1, Q2, Q3, Q4, Q5, Q6, Q7, and Q8 corresponding to the progress of the processing cycles. In the bit-reversed order, s pieces out of i*s pieces of data supplied in the sequential order are arranged from the first piece in the order of cycles, and i pieces of data in the same cycle are sequentially arranged as a set.

Each data set in the bit-reversed order is uniquely determined in a case where each data set in the sequential order is configured. The i-th data Qs(i) (i=0, . . . , 7) out of data constituting each data set Qs (s=1, . . . , 8) in the bit-reversed order is the (s−1)-th piece of data Pᵢ₊₁(s−1) in the (i+1)-th cycle according to the sequential order. That is,

Qs(i)=Pᵢ₊₁(s−1).

Here, if the i-th data in Ps and Qs (s=1, . . . , 8) are represented by Ps(i) and Qs(i) (i=1, . . . , 8), the above equation is expressed as:

Qs(i)=Pi(s)

That is, Qs(i) and Pi(s) have a relationship in which the progress order of cycles is replaced by the order of data positions with respect to pieces of data constituting each data set. Hence, if pieces of data supplied in the bit-reversed order are rearranged according to the bit-reversed order, they will form a sequence in the sequential order.

Each row pₛ(ᵢ) in FIG. 8 and eight rows qₛ(i) in FIG. 9 represent the i-th data to be supplied in the subsequent stage. Each of eight numerals included in each data set is an identifier specifying an FFT point and is specifically the index n in x(n).

The sequential order and the bit-reversed order are, as a matter of course, not limited to those illustrated in FIGS. 8 and 9. Each data set in the sequential order may be created by sequentially arranging data according to the number of FFT points, the number of cycles, and the number of data processed in parallel, as described above. Each data set in the bit-reversed order may be created by replacing the order of cycle progression with the order of data position, for data supplied in the sequential order, as described above.

The first butterfly operation processing part 32a performs the first processing of the butterfly operation processing part 502 out of the radix-8 butterfly operation processing performed twice in the data flow 500 illustrated in FIG. 26.

The first butterfly operation processing part 32a outputs the results of the butterfly operation in the sequential order as illustrated in FIG. 8 as data y(n) (n=0, 1, . . . , 63).

The second data reordering processing part 240b rearranges the data y(n) outputted in the sequential order by the first butterfly operation processing part 32a to the bit-reversed order as illustrated in FIG. 9 in order to supply the data to the second butterfly operation processing part 32b.

The twiddle factor multiplication processing part 33 applies complex rotation on a complex plane of the FFT operation after the first butterfly operation, which corresponds to the twiddle factor multiplication processing part 504 in the data flow 500 illustrated in FIG. 26.

Data rearrangement is not performed by the twiddle factor multiplication processing part 33.

The second butterfly operation processing part 32b, which corresponds to a butterfly operation processing circuit, performs the second butterfly operation processing by the radix-8 butterfly operation processing part 503 in the data flow diagram illustrated in FIG. 26.

The second butterfly operation processing part 32b performs butterfly operation processing on data y′(n) (n=0, 1, . . . , 63) supplied in the bit-reversed order after the twiddle factor multiplication and outputs the results X(k) (k=0, 1, . . . , 63), also in the bit-reversed order.

The third data reordering processing part 250c rearranges the data X(k) outputted in the bit-reversed order by the second butterfly operation processing part 32b to the sequential order illustrated in FIG. 8.

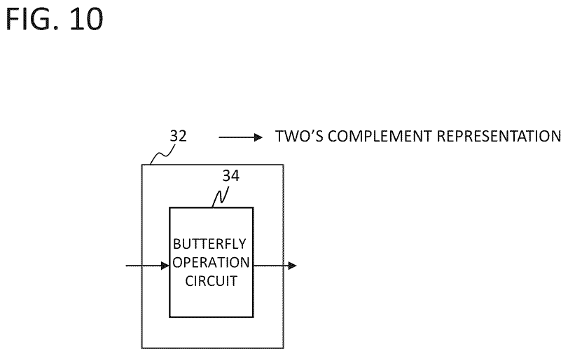

Referring to FIG. 10, a butterfly operation processing part 32 constituting the first butterfly operation processing part 32a and the second butterfly operation processing part 32b includes a butterfly operation circuit 34.

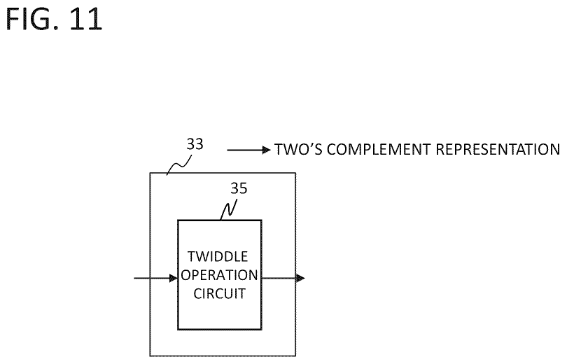

Referring to FIG. 11, the twiddle factor multiplication processing part 33 includes a twiddle factor operation circuit 35.

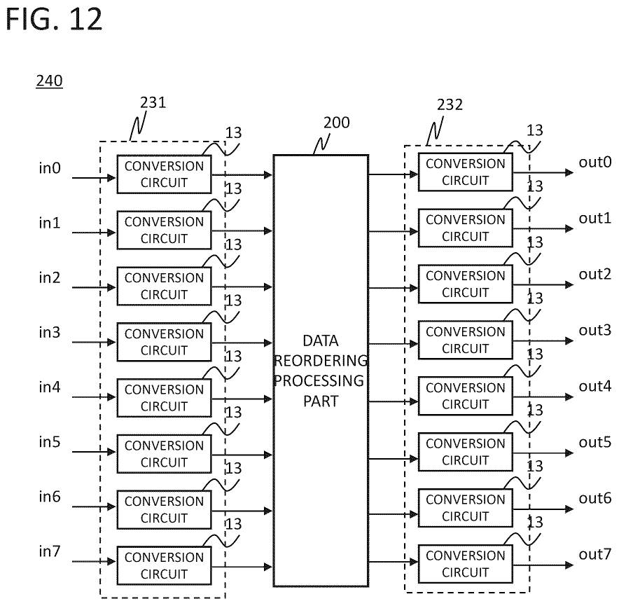

The first and the second data reordering processing parts 240a and 240b may have identical arrangement and may be implemented by a data reordering processing part 240 (data reordering circuit) illustrated in FIG. 12 for example. Referring to FIG. 12, the data reordering processing part 240 is constituted by a conversion circuit 231, a data reordering processing part 200, and a conversion circuit 232. The data reordering processing part 240 receives supplied signal data represented in the two's complement representation, performs data reordering processing thereon, and outputs a result as signal data represented in the two's complement representation.

More specifically, the conversion circuit 231 is configured to simultaneously receive eight pieces of data supplied from eight inputs in0 to in7 in the sequential order illustrated in FIG. 8 and convert the data in two's complement representation to those in the partial sign magnitude—representation.

The conversion circuit 231 is constituted by eight conversion circuits 13 corresponding to the eight inputs and converts the data represented in the two's complement representation, supplied in parallel, to those in the partial sign magnitude—representation. More specifically, the conversion circuits convert the data to those in the partial sign magnitude—representation by inverting all bits in the supplied data of D-bits except for the most significant bit indicating a sign and the N least significant bits (N is a positive integer such that N≤D−2).

The conversion circuit 232 is configured to convert data represented in the partial sign magnitude—representation, outputted by the data reordering processing part 200, to those in the two's complement representation.

The conversion circuit 232 is constituted by eight conversion circuits 13 corresponding to the eight inputs and converts data represented in the two's complement representation, supplied in parallel, to those in the partial sign magnitude—representation. More specifically, the conversion circuits convert the data to those in the partial sign magnitude—representation by inverting all bits in the supplied data of D-bits except for the most significant bit indicating a sign and the N least significant bits (N is a positive integer such that N≤D−2).

The data reordering processing part 200 realizes data reordering processing according to the sequential order illustrated in FIG. 8 and the bit-reversed order illustrated in FIG. 9 by temporarily storing received data converted to the partial sign magnitude—representation by the conversion circuit 231 and controlling selection and output of the stored data.

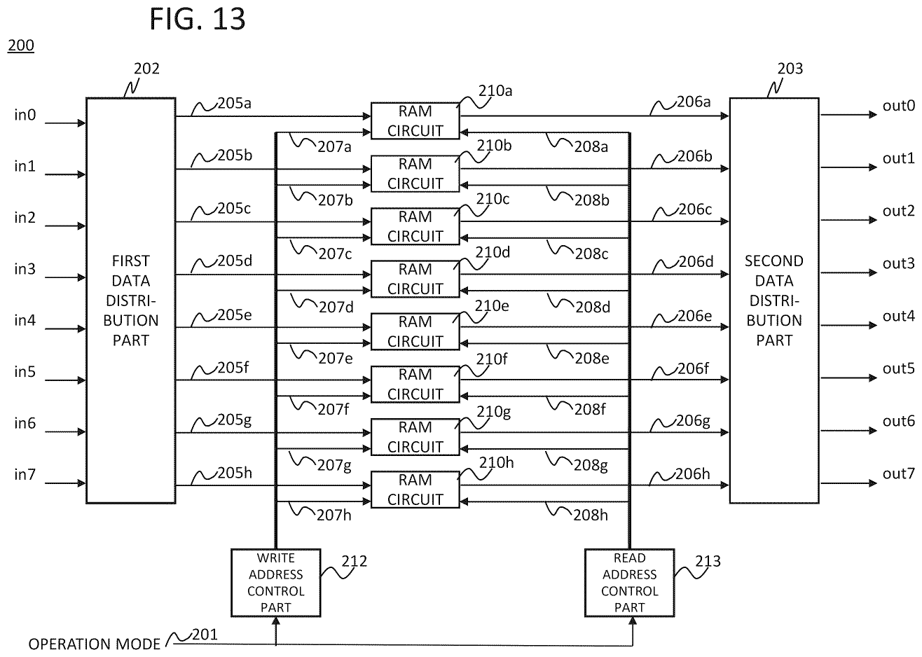

FIG. 13 illustrates a configuration example of the data reordering processing part 200. Referring to FIG. 13, the data reordering processing part 200 is constituted by a first data distribution part 202, eight RAM circuits 210a, 210b, 210c, 210d, 210e, 210f, 210g, and 210h, a second data distribution part 203, a write address control part 212, and a read address control part 213.

The first data distribution part 202 performs data distribution processing on supplied data represented in the partial sign magnitude—representation and outputs the results to eight outputs 205a to 205h.

Each of the RAM circuits 210a to 210h is a RAM circuit enabled to store eight pieces of data. Therefore, the RAM circuits 210a to 210h are enabled to store a total of 64 pieces of data, which is equal to the number of points in a 64-point FFT. Each of the RAM circuits 210a to 210h may be a dual-port RAM circuit that includes independent write and read ports and prioritizes reading when both writing and reading occur at the same address simultaneously. That is, after reading data stored at a target address for writing and reading, the RAM circuit writes data to be written.

The RAM circuit 210a stores the data outputted by the first data distribution part 202 to 205a at an address outputted by the write address control part 212 to a write address 207a, reads the stored data using an address outputted by the read address control part 213 to a read address 208a, and outputs the result to 206a.

Likewise, the RAM circuit 210b stores the data outputted by the first data distribution part 202 to 205b at an address outputted by the write address control part 212 to a write address 207b, reads the stored data using an address outputted by the read address control part 213 to a read address 208b, and outputs the result to 206b.

The RAM circuit 210c stores the data outputted by the first data distribution part 202 to 205c at an address outputted by the write address control part 212 to a write address 207c, reads the stored data using an address outputted by the read address control part 213 to a read address 208c, and outputs the result to 206c.

The RAM circuit 210d stores the data outputted by the first data distribution part 202 to 205d at an address outputted by the write address control part 212 to an address 207d, reads the stored data using an address outputted by the read address control part 213 to a read address 208d, and outputs the result to 206d.

The RAM circuit 210e stores the data outputted by the first data distribution part 202 to 205e at an address outputted by the write address control part 212 to a write address 207e, reads the stored data using an address outputted by the read address control part 213 to a read address 208e, and outputs the result to 206e.

The RAM circuit 210f stores the data outputted by the first data distribution part 202 to 205f at an address outputted by the write address control part 212 to a write address 207f, reads the stored data using an address outputted by the read address control part 213 to a read address 208f, and outputs the result to 206f.

The RAM circuit 210g stores the data outputted by the first data distribution part 202 to 205g at an address outputted by the write address control part 212 to a write address 207g, reads the stored data using an address outputted by the read address control part 213 to a read address 208g, and outputs the result to 206g.

The RAM circuit 210h stores the data outputted by the first data distribution part 202 to 205h at an address outputted by the write address control part 212 to a write address 207h, reads the stored data using an address outputted by the read address control part 213 to a read address 208h, and outputs the result to 206h.

The second data distribution part 203 simultaneously receives eight pieces of data from the eight inputs 206a to 206h, performs data distribution processing, and outputs the results to the conversion circuit 232.

The write address control part 212 refers to an operation mode 201 and outputs the addresses with which the RAM circuits 210a to 210h write data to 207a to 207h, respectively.

The read address control part 213 refers to the operation mode 201 and outputs the addresses with which the RAM circuits 210a to 210h read data to 208a to 208h, respectively.

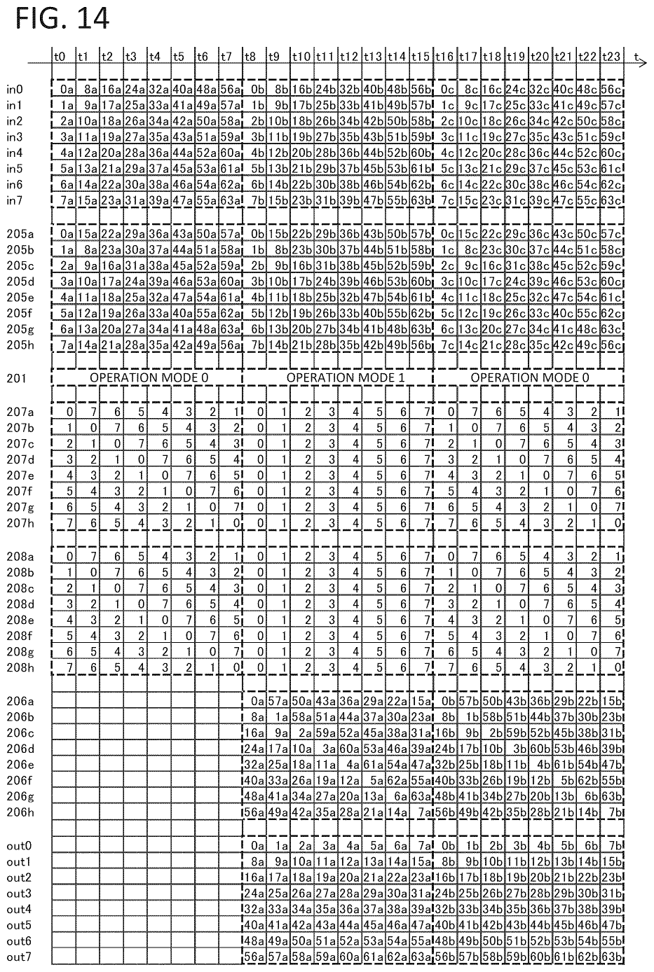

The following describes a specific operation of the data reordering processing part 200. FIG. 14 is a time chart showing an example of an operation of the data reordering processing part 200.

The data reordering processing part 200 receives 64 pieces of data 0a to 63a in 8-data parallel in the sequential order from the inputs in0 to in7 in eight cycles t0 to t7 and outputs 64 pieces of data 0a to 63a in 8-data parallel in the bit-reversed order to outputs out0 to out7 in eight cycles t8 to t15.

Likewise, the data reordering processing part 200 receives 64 pieces of data 0b to 63b in 8-data parallel in the sequential order from the inputs in0 to in7 in the eight cycles t8 to t15 and outputs 64 pieces of data 0b to 63b in 8-data parallel in the bit-reversed order to the outputs out0 to out7 in eight cycles t16 to t23. Further, the data reordering processing part 200 receives 64 pieces of data 0c to 63c in 8-data parallel in the sequential order from the inputs in0 to in7 in the eight cycles t16 to t23 and outputs 64 pieces of data 0c to 63c in 8-data parallel in the bit-reversed order to the outputs out0 to out7 in eight cycles t24 to t31 (not shown in the drawing).

First, the following describes in detail how the data 0a to 63a are inputted in the eight cycles t0 to t7.

In the cycle t0,
the first data distribution part 202
outputs to 205a the data 0a received from in0,
outputs to 205b the data 1a received from in1,
outputs to 205c the data 2a received from in2,
outputs to 205d the data 3a received from in3,
outputs to 205e the data 4a received from in4,
outputs to 205f the data 5a received from in5,
outputs to 205g the data 6a received from in6, and
outputs to 205h the data 7a received from in7.

In the cycle t1,
the first data distribution part 202
outputs to 205b the data 8a received from in0,
outputs to 205c the data 9a received from in1,
outputs to 205d the data 10a received from in2,
outputs to 205e the data 11a received from in3,
outputs to 205f the data 12a received from in4,
outputs to 205g the data 13a received from in5,
outputs to 205h the data 14a received from in6, and
outputs to 205a the data 15a received from in7.

In the cycle t2,
the first data distribution part 202
outputs to 205c the data 16a received from in0,
outputs to 205d the data 17a received from in1,
outputs to 205e the data 18a received from in2,
outputs to 205f the data 19a received from in3,
outputs to 205g the data 20a received from in4,
outputs to 205h the data 21a received from in5,
outputs to 205a the data 22a received from in6, and
outputs to 205b the data 23a received from in7.

In the cycle t3,
the first data distribution part 202
outputs to 205d the data 24a received from in0,
outputs to 205e the data 25a received from in1,
outputs to 205f the data 26a received from in2,
outputs to 205g the data 27a received from in3,
outputs to 205h the data 28a received from in4,
outputs to 205a the data 29a received from in5,
outputs to 205b the data 30a received from in6, and
outputs to 205c the data 31a received from in7.

In the cycle t4,
the first data distribution part 202
outputs to 205e the data 32a received from in0,
outputs to 205f the data 33a received from in1,
outputs to 205g the data 34a received from in2,
outputs to 205h the data 35a received from in3,
outputs to 205a the data 36a received from in4,
outputs to 205b the data 37a received from in5,
outputs to 205c the data 38a received from in6, and
outputs to 205d the data 39a received from in7.

In the cycle t5,
the first data distribution part 202
outputs to 205f the data 40a received from in0,
outputs to 205g the data 41a received from in1,
outputs to 205h the data 42a received from in2,
outputs to 205a the data 43a received from in3,
outputs to 205b the data 44a received from in4,
outputs to 205c the data 45a received from in5,
outputs to 205d the data 46a received from in6, and
outputs to 205e the data 47a received from in7.

In the cycle t6,
the first data distribution part 202
outputs to 205g the data 48a received from in0,
outputs to 205h the data 49a received from in1,
outputs to 205a the data 50a received from in2,
outputs to 205b the data 51a received from in3,
outputs to 205c the data 52a received from in4,
outputs to 205d the data 53a received from in5,
outputs to 205e the data 54a received from in6, and
outputs to 205f the data 55a received from in7.

In the cycle t7,
the first data distribution part 202
outputs to 205h the data 56a received from in0,
outputs to 205a the data 57a received from in1,
outputs to 205b the data 58a received from in2,
outputs to 205c the data 59a received from in3,
outputs to 205d the data 60a received from in4,
outputs to 205e the data 61a received from in5,
outputs to 205f the data 62a received from in6, and
outputs to 205g the data 63a received from in7.

As described above, the first data distribution part 202 performs rotation processing on eight pieces of data simultaneously received in parallel and outputs the results. It may be easily realized by, for example, a shift circuit.

Likewise, the first data distribution part 202 performs assignment operation on the data 0b to 63b in the cycles t8 to t15, and the data 0c to 63c in the cycles t16 to t23.

The next describes read and write operations of the write address control part 212, the read address control part 213, and the RAM circuits 210a to 210h controlled thereby.

The write address control part 212 and the read address control part 213 operate by referring to the operation mode 201. Here, the operation mode 201 is a control signal provided by a higher-level control circuit (not shown in the drawing) such as a CPU and is either a first or a second operation mode. The operation mode 201 indicates the same operation mode for eight consecutive cycles in which data for the number of points in a 64-point FFT is supplied and indicates a different operation mode every eight cycles.

More specifically, in FIG. 14, the operation mode 201 indicates operation mode 0, which is the first operation mode, in the eight cycles t0 to t7 in which the data 0a to 63a are supplied. The operation mode 201 indicates operation mode 1, which is the second operation mode, in the eight cycles t8 to t15 in which the data 0b to 63b are supplied. The operation mode 201 indicates the operation mode 0 (the first operation mode) again in the eight cycles t16 to t23 in which the data 0c to 63c are supplied. The operation mode 201 is a signal that alternately indicates the operation mode 0 or the operation mode 1 every eight cycles thereafter.

The write address control part 212 generates a write address according to a first address order when the operation mode 201 is the operation mode 0 (the first operation mode). The write address control part 212 generates a write address according to a second address order when the operation mode 201 is the operation mode 1 (the second operation mode). The first address order is an address order that always specifies a different address for each of the RAM circuits 210a to 210h.

In other words, in the first operation mode, different addresses from each other are always outputted to 207a to 207h. The second address order is an address order that always specifies the same address for each of the RAM circuits 210a to 210h. In other words, in the second operation mode, the same address is always outputted to each of 207a to 207h.

The read address control part 213 operates in the same manner as the write address control part 212. In other words, the read address control part 213 generates a write address according to the first address order when the operation mode 201 is the operation mode 0 (the first operation mode). The read address control part 213 generates a write address according to the second address order when the operation mode 201 is the operation mode 1 (the second operation mode).

Referring to FIG. 14, the following describes a concrete example of read and write operations of the write address control part 212, the read address control part 213, and the RAM circuits 210a to 210h.

First, in the eight cycles t0 to t7, the data 0a to 63a are written to the RAM circuits 210a to 210h.

In the eight cycles t8 to t15, the data 0a to 63a written in the RAM circuits 210a to 210h are read while the data 0b to 63b are written to the RAM circuits 210a to 210h.

In the eight cycles t16 to t23, the data 0b to 63b written in the RAM circuits 210a to 210h are read while the data 0c to 63c are written to the RAM circuits 210a to 210h.

Note that, although data written in previous eight cycles before t0 to t7 are read in the eight cycles t0 to t7, this is not shown in the drawing.

As is evident from FIG. 14, read and write operations of the RAM circuits 210a to 210h are always performed on the same address in the same cycle. The RAM circuits 210a to 210h prioritize reading when both writing and reading occur at the same address simultaneously. Therefore, in the RAM circuits 210a to 210h, the data 0b to 63b are written after the data 0a to 63a have been read in each of the cycles t8 to t15. Likewise, in each of the cycles t16 to t23, the data 0c to 63c are written after the data 0b to 63b have been read.

The next describes in detail write operations of the write address control part 212 and the RAM circuits 210a to 210h controlled thereby in the cycles t0 to t7.

Referring to FIG. 14, in the eight cycles t0 to t7, the operation mode 201 indicates the operation mode 0 (the first operation mode), and the write address control part 212 generates write addresses according to the first address order. The RAM circuits 210a to 210h write data outputted to the write addresses 207a to 207h by the first data distribution part 202 to the write addresses generated by the write address control part 212.

More specifically,
in the cycle t0,
the RAM circuit 210a writes the data 0a to an address 0 outputted to the write address 207a by the write address control part 212,
the RAM circuit 210b writes the data 1a to an address 1 outputted to the write address 207b by the write address control part 212,
the RAM circuit 210c writes the data 2a to an address 2 outputted to the write address 207c by the write address control part 212,
the RAM circuit 210d writes the data 3a to an address 3 outputted to the write address 207d by the write address control part 212,
the RAM circuit 210e writes the data 4a to an address 4 outputted to the write address 207e by the write address control part 212,
the RAM circuit 210f writes the data 5a to an address 5 outputted to the write address 207f by the write address control part 212,
the RAM circuit 210g writes the data 6a to an address 6 outputted to the write address 207g by the write address control part 212, and
the RAM circuit 210h writes the data 7a to an address 7 outputted to the write address 207h by the write address control part 212.

In the cycle t1,
the RAM circuit 210a writes the data 15a to the address 7 outputted to the write address 207a by the write address control part 212,
the RAM circuit 210b writes the data 8a to the address 0 outputted to the write address 207b by the write address control part 212,
the RAM circuit 210c writes the data 9a to the address 1 outputted to the write address 207c by the write address control part 212,
the RAM circuit 210d writes the data 10a to the address 2 outputted to the write address 207d by the write address control part 212,
the RAM circuit 210e writes the data 11a to the address 3 outputted to the write address 207e by the write address control part 212,
the RAM circuit 210f writes the data 12a to the address 4 outputted to the write address 207f by the write address control part 212,
the RAM circuit 210g writes the data 13a to the address 5 outputted to the write address 207g by the write address control part 212, and
the RAM circuit 210h writes the data 14a to the address 6 outputted to the write address 207h by the write address control part 212.

In the cycle t2,
the RAM circuit 210a writes the data 22a to the address 6 outputted to the write address 207a by the write address control part 212,
the RAM circuit 210b writes the data 23a to the address 7 outputted to the write address 207b by the write address control part 212,
the RAM circuit 210c writes the data 16a to the address 0 outputted to the write address 207c by the write address control part 212,
the RAM circuit 210d writes the data 17a to the address 1 outputted to the write address 207d by the write address control part 212,
the RAM circuit 210e writes the data 18a to the address 2 outputted to the write address 207e by the write address control part 212,
the RAM circuit 210f writes the data 19a to the address 3 outputted to the write address 207f by the write address control part 212,
the RAM circuit 210g writes the data 20a to the address 4 outputted to the write address 207g by the write address control part 212, and
the RAM circuit 210h writes the data 21a to the address 5 outputted to the write address 207h by the write address control part 212.

In the cycle t3,
the RAM circuit 210a writes the data 29a to the address 5 outputted to the write address 207a by the write address control part 212,
the RAM circuit 210b writes the data 30a to the address 6 outputted to the write address 207b by the write address control part 212,
the RAM circuit 210c writes the data 31a to the address 7 outputted to the write address 207c by the write address control part 212,
the RAM circuit 210d writes the data 24a to the address 0 outputted to the write address 207d by the write address control part 212,
the RAM circuit 210e writes the data 25a to the address 1 outputted to the write address 207e by the write address control part 212,
the RAM circuit 210f writes the data 26a to the address 2 outputted to the write address 207f by the write address control part 212,
the RAM circuit 210g writes the data 27a to the address 3 outputted to the write address 207g by the write address control part 212, and
the RAM circuit 210h writes the data 28a to the address 4 outputted to the write address 207h by the write address control part 212.

In the cycle t4,
the RAM circuit 210a writes the data 36a to the address 4 outputted to the write address 207a by the write address control part 212,
the RAM circuit 210b writes the data 37a to the address 5 outputted to the write address 207b by the write address control part 212,
the RAM circuit 210c writes the data 38a to the address 6 outputted to the write address 207c by the write address control part 212,
the RAM circuit 210d writes the data 39a to the address 7 outputted to the write address 207d by the write address control part 212,
the RAM circuit 210e writes the data 32a to the address 0 outputted to the write address 207e by the write address control part 212,
the RAM circuit 210f writes the data 33a to the address 1 outputted to the write address 207f by the write address control part 212,
the RAM circuit 210g writes the data 34a to the address 2 outputted to the write address 207g by the write address control part 212, and
the RAM circuit 210h writes the data 35a to the address 3 outputted to the write address 207h by the write address control part 212.

In the cycle t5,
the RAM circuit 210a writes the data 43a to the address 3 outputted to the write address 207a by the write address control part 212,
the RAM circuit 210b writes the data 44a to the address 4 outputted to the write address 207b by the write address control part 212,
the RAM circuit 210c writes the data 45a to the address 5 outputted to the write address 207c by the write address control part 212,
the RAM circuit 210d writes the data 46a to the address 6 outputted to the write address 207d by the write address control part 212,
the RAM circuit 210e writes the data 47a to the address 7 outputted to the write address 207e by the write address control part 212,
the RAM circuit 210f writes the data 40a to the address 0 outputted to the write address 207f by the write address control part 212,
the RAM circuit 210g writes the data 41a to the address 1 outputted to the write address 207g by the write address control part 212, and
the RAM circuit 210h writes the data 42a to the address 2 outputted to the write address 207h by the write address control part 212.

In the cycle t6,
the RAM circuit 210a writes the data 50a to the address 2 outputted to the write address 207a by the write address control part 212,
the RAM circuit 210b writes the data 51a to the address 3 outputted to the write address 207b by the write address control part 212,
the RAM circuit 210c writes the data 52a to the address 4 outputted to the write address 207c by the write address control part 212,
the RAM circuit 210d writes the data 53a to the address 5 outputted to the write address 207d by the write address control part 212,
the RAM circuit 210e writes the data 54a to the address 6 outputted to the write address 207e by the write address control part 212,
the RAM circuit 210f writes the data 55a to the address 7 outputted to the write address 207f by the write address control part 212,
the RAM circuit 210g writes the data 48a to the address 0 outputted to the write address 207g by the write address control part 212, and
the RAM circuit 210h writes the data 49a to the address 1 outputted to the write address 207h by the write address control part 212.

In the cycle t7,
the RAM circuit 210a writes the data 57a to the address 1 outputted to the write address 207a by the write address control part 212,
the RAM circuit 210b writes the data 58a to the address 2 outputted to the write address 207b by the write address control part 212,
the RAM circuit 210c writes the data 59a to the address 3 outputted to the write address 207c by the write address control part 212,
the RAM circuit 210d writes the data 60a to the address 4 outputted to the write address 207d by the write address control part 212,
the RAM circuit 210e writes the data 61a to the address 5 outputted to the write address 207e by the write address control part 212,
the RAM circuit 210f writes the data 62a to the address 6 outputted to the write address 207f by the write address control part 212,
the RAM circuit 210g writes the data 63a to the address 7 outputted to the write address 207g by the write address control part 212, and
the RAM circuit 210h writes the data 56a to the address 0 outputted to the write address 207h by the write address control part 212.

As described above, in the first address order, addresses different from each other are outputted to the write addresses 207a to 207h that specify the write addresses of the RAM circuits 210a to 210h.

In each of the cycles t0 to t7, a different address is outputted to each of the write addresses 207a to 207h. For instance, different addresses, the addresses 0 to 7, are outputted to the write address 207a in the cycles t0 to t7.

The next describes a concrete example of read operations of the read address control part 213 and the RAM circuits 210a to 210h controlled thereby in the cycles t8 to t15.

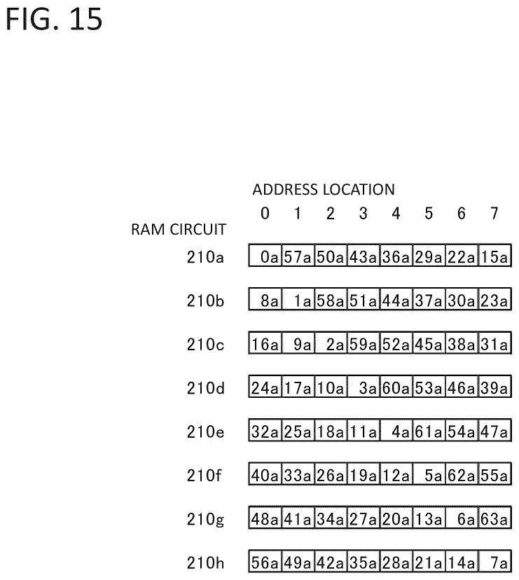

As a result of the write operations in the cycles t0 to t7, at the time of the cycle t8, the RAM circuits 210a to 210h store the data 0a to 63a, as shown in FIG. 15.

In the eight cycles t8 to t15, the operation mode 201 indicates the operation mode 1 (the second operation mode), and the read address control part 213 generates read addresses according to the second address order. The RAM circuits 210a to 210h output the stored data to the outputs 206a to 206h from the read addresses generated by the read address control part 213.

More specifically,
in the cycle t8,
the read address control part 213 outputs the address 0 to all the read addresses 208a to 208h,
the RAM circuit 210a reads the data 0a from the address 0,
the RAM circuit 210b reads the data 8a from the address 0,
the RAM circuit 210c reads the data 16a from the address 0,
the RAM circuit 210d reads the data 24a from the address 0,
the RAM circuit 210e reads the data 32a from the address 0,
the RAM circuit 210f reads the data 40a from the address 0,
the RAM circuit 210g reads the data 48a from the address 0, and
the RAM circuit 210h reads the data 56a from the address 0.

In the cycle t9,
the read address control part 213 outputs the address 1 to all the read addresses 208a to 208h,
the RAM circuit 210a reads the data 57a from the address 1,
the RAM circuit 210b reads the data 1a from the address 1,
the RAM circuit 210c reads the data 9a from the address 1,
the RAM circuit 210d reads the data 17a from the address 1,
the RAM circuit 210e reads the data 25a from the address 1,
the RAM circuit 210f reads the data 33a from the address 1,
the RAM circuit 210g reads the data 41a from the address 1, and
the RAM circuit 210h reads the data 49a from the address 1.

In the cycle t10,
the read address control part 213 outputs the address 2 to all the read addresses 208a to 208h,
the RAM circuit 210a reads the data 50a from the address 2,
the RAM circuit 210b reads the data 58a from the address 2,
the RAM circuit 210c reads the data 2a from the address 2,
the RAM circuit 210d reads the data 10a from the address 2,
the RAM circuit 210e reads the data 18a from the address 2,
the RAM circuit 210f reads the data 26a from the address 2,
the RAM circuit 210g reads the data 34a from the address 2, and
the RAM circuit 210h reads the data 42a from the address 2.

In the cycle t11,
the read address control part 213 outputs the address 3 to all the read addresses 208a to 208h,
the RAM circuit 210a reads the data 43a from the address 3,
the RAM circuit 210b reads the data 51a from the address 3,
the RAM circuit 210c reads the data 59a from the address 3,
the RAM circuit 210d reads the data 3a from the address 3,
the RAM circuit 210e reads the data 11a from the address 3,
the RAM circuit 210f reads the data 19a from the address 3,
the RAM circuit 210g reads the data 27a from the address 3, and
the RAM circuit 210h reads the data 35a from the address 3.

In the cycle t12,
the read address control part 213 outputs the address 4 to all the read addresses 208a to 208h,
the RAM circuit 210a reads the data 36a from the address 4,
the RAM circuit 210b reads the data 44a from the address 4,
the RAM circuit 210c reads the data 52a from the address 4,
the RAM circuit 210d reads the data 60a from the address 4,
the RAM circuit 210e reads the data 4a from the address 4,
the RAM circuit 210f reads the data 12a from the address 4,
the RAM circuit 210g reads the data 20a from the address 4, and
the RAM circuit 210h reads the data 28a from the address 4.

In the cycle t13,
the read address control part 213 outputs the address 5 to all the read addresses 208a to 208h,
the RAM circuit 210a reads the data 29a from the address 5,
the RAM circuit 210b reads the data 37a from the address 5,
the RAM circuit 210c reads the data 45a from the address 5,
the RAM circuit 210d reads the data 53a from the address 5,
the RAM circuit 210e reads the data 61a from the address 5,
the RAM circuit 210f reads the data 5a from the address 5,
the RAM circuit 210g reads the data 13a from the address 5, and
the RAM circuit 210h reads the data 21a from the address 5.

In the cycle t14,
the read address control part 213 outputs the address 6 to all the read addresses 208a to 208h,
the RAM circuit 210a reads the data 22a from the address 6,
the RAM circuit 210b reads the data 30a from the address 6,
the RAM circuit 210c reads the data 38a from the address 6,
the RAM circuit 210d reads the data 46a from the address 6,
the RAM circuit 210e reads the data 54a from the address 6,
the RAM circuit 210f reads the data 62a from the address 6,
the RAM circuit 210g reads the data 6a from the address 6, and
the RAM circuit 210h reads the data 14a from the address 6.

In the cycle t15,
the read address control part 213 outputs the address 7 to all the read addresses 208a to 208h,
the RAM circuit 210a reads the data 15a from the address 7,
the RAM circuit 210b reads the data 23a from the address 7,
the RAM circuit 210c reads the data 31a from the address 7,
the RAM circuit 210d reads the data 39a from the address 7,
the RAM circuit 210e reads the data 47a from the address 7,
the RAM circuit 210f reads the data 55a from the address 7,
the RAM circuit 210g reads the data 63a from the address 7, and
the RAM circuit 210h reads the data 7a from the address 7.

As described above, in the second address order, the same address is outputted to all the read addresses 208a to 208h that specify the read addresses of the RAM circuits 210a to 210h.

In each of the cycles t8 to t15, a different address is outputted to each of the read addresses 208a to 208h. For instance, different addresses, the addresses 0 to 7, are outputted to the write address 208a in the cycles t8 to t15.

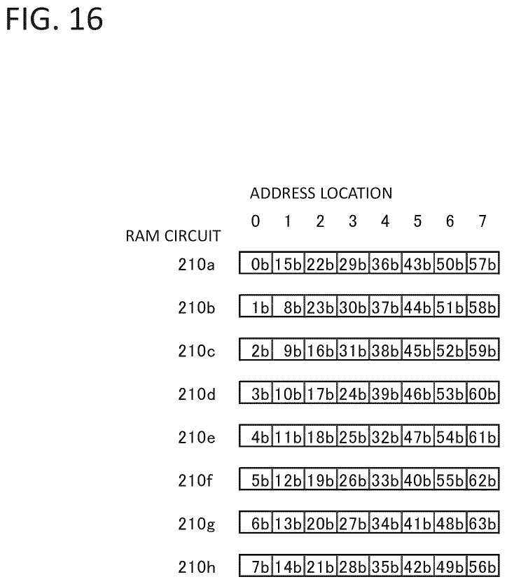

FIG. 16 shows a concrete example of write operations of the write address control part 212 and the RAM circuits 210a to 210h controlled thereby in the cycles t8 to t15.

In the eight cycles t8 to t15, the operation mode 201 indicates the operation mode 1 (the second operation mode), and the write address control part 212 generates write addresses according to the second address order. The RAM circuits 210a to 210h write data outputted to the outputs 207a to 207h by the first data distribution part 202 to the write addresses generated by the write address control part 212.

More specifically,
in the cycle t8,
the write address control part 212 outputs the address 0 to all the write addresses 207a to 207h,
the RAM circuit 210a writes the data 0b to the address 0,
the RAM circuit 210b writes the data 1b to the address 0,
the RAM circuit 210c writes the data 2b to the address 0,
the RAM circuit 210d writes the data 3b to the address 0,
the RAM circuit 210e writes the data 4b to the address 0,
the RAM circuit 210f writes the data 5b to the address 0,
the RAM circuit 210g writes the data 6b to the address 0, and
the RAM circuit 210h writes the data 7b to the address 0.

In the cycle t9,
the write address control part 212 outputs the address 1 to all the write addresses 207a to 207h,
the RAM circuit 210a writes the data 15b to the address 1,
the RAM circuit 210b writes the data 8b to the address 1,
the RAM circuit 210c writes the data 9b to the address 1,
the RAM circuit 210d writes the data 10b to the address 1,
the RAM circuit 210e writes the data 11b to the address 1,
the RAM circuit 210f writes the data 12b to the address 1,
the RAM circuit 210g writes the data 13b to the address 1, and
the RAM circuit 210h writes the data 14b to the address 1.

In the cycle t10,
the write address control part 212 outputs the address 2 to all the write addresses 207a to 207h,
the RAM circuit 210a writes the data 22b to the address 2,
the RAM circuit 210b writes the data 23b to the address 2,
the RAM circuit 210c writes the data 16b to the address 2,
the RAM circuit 210d writes the data 17b to the address 2,
the RAM circuit 210e writes the data 18b to the address 2,
the RAM circuit 210f writes the data 19b to the address 2,
the RAM circuit 210g writes the data 20b to the address 2, and
the RAM circuit 210h writes the data 21b to the address 2.

In the cycle t11,
the write address control part 212 outputs the address 3 to all the write addresses 207a to 207h,
the RAM circuit 210a writes the data 29b to the address 3,
the RAM circuit 210b writes the data 30b to the address 3,
the RAM circuit 210c writes the data 31b to the address 3,
the RAM circuit 210d writes the data 24b to the address 3,
the RAM circuit 210e writes the data 25b to the address 3,
the RAM circuit 210f writes the data 26b to the address 3,
the RAM circuit 210g writes the data 27b to the address 3, and
the RAM circuit 210h writes the data 28b to the address 3.

In the cycle t12,
the write address control part 212 outputs the address 4 to all the write addresses 207a to 207h,
the RAM circuit 210a writes the data 36b to the address 4,
the RAM circuit 210b writes the data 37b to the address 4,
the RAM circuit 210c writes the data 38b to the address 4,
the RAM circuit 210d writes the data 39b to the address 4,
the RAM circuit 210e writes the data 32b to the address 4,
the RAM circuit 210f writes the data 33b to the address 4,
the RAM circuit 210g writes the data 34b to the address 4, and
the RAM circuit 210h writes the data 35b to the address 4.

In the cycle t13,
the write address control part 212 outputs the address 5 to all the write addresses 207a to 207h,
the RAM circuit 210a writes the data 43b to the address 5,
the RAM circuit 210b writes the data 44b to the address 5,
the RAM circuit 210c writes the data 45b to the address 5,
the RAM circuit 210d writes the data 46b to the address 5,
the RAM circuit 210e writes the data 47b to the address 5,
the RAM circuit 210f writes the data 40b to the address 5,
the RAM circuit 210g writes the data 41b to the address 5, and
the RAM circuit 210h writes the data 42b to the address 5.

In the cycle t14,
the write address control part 212 outputs the address 6 to all the write addresses 207a to 207h,
the RAM circuit 210a writes the data 50b to the address 6,
the RAM circuit 210b writes the data 51b to the address 6,
the RAM circuit 210c writes the data 52b to the address 6,
the RAM circuit 210d writes the data 53b to the address 6,
the RAM circuit 210e writes the data 54b to the address 6,
the RAM circuit 210f writes the data 55b to the address 6,
the RAM circuit 210g writes the data 48b to the address 6, and
the RAM circuit 210h writes the data 49b to the address 6.

In the cycle t15,
the write address control part 212 outputs the address 7 to all the write addresses 207a to 207h,
the RAM circuit 210a writes the data 57b to the address 7,
the RAM circuit 210b writes the data 58b to the address 7,
the RAM circuit 210c writes the data 59b to the address 7,
the RAM circuit 210d writes the data 60b to the address 7,
the RAM circuit 210e writes the data 61b to the address 7,
the RAM circuit 210f writes the data 62b to the address 7,
the RAM circuit 210g writes the data 63b to the address 7, and
the RAM circuit 210h writes the data 56b to the address 7.

As described above, in the second address order, the same address is outputted to all the write addresses 207a to 207h that specify the write addresses of the RAM circuits 210a to 210h.

In each of the cycles t8 to t15, a different address is outputted to each of the write addresses 207a to 207h. For instance, different addresses, the addresses 0 to 7, are outputted to the write address 207a in the cycles t0 to t7.

The next describes a concrete example of read operations of the read address control part 213 and the RAM circuits 210a to 210h controlled thereby in the cycles t16 to t23.

As a result of the write operations in the cycles t8 to t15, at the time of the cycle t16, the RAM circuits 210a to 210h store the data 0b to 63b, as shown in FIG. 16.

In the eight cycles t16 to t23, the operation mode 201 indicates the operation mode 0 (the first operation mode), and the read address control part 213 generates read addresses according to the first address order. The RAM circuits 210a to 210h output the stored data to the outputs 206a to 206h from the read addresses generated by the read address control part 213.

More specifically,
in the cycle t16,
the RAM circuit 210a reads the data 0b from the address 0 outputted to the read address 208a by the read address control part 213,
the RAM circuit 210b reads the data 8b from the address 1 outputted to the read address 208b by the read address control part 213,
the RAM circuit 210c reads the data 16b from the address 2 outputted to the read address 208c by the read address control part 213,
the RAM circuit 210d reads the data 24b from the address 3 outputted to the read address 208d by the read address control part 213,
the RAM circuit 210e reads the data 32b from the address 4 outputted to the read address 208e by the read address control part 213,
the RAM circuit 210f reads the data 40b from the address 5 outputted to the read address 208f by the read address control part 213,
the RAM circuit 210g reads the data 48b from the address 6 outputted to the read address 208g by the read address control part 213, and
the RAM circuit 210h reads the data 56b from the address 7 outputted to the read address 208h by the read address control part 213.

In the cycle t17,
the RAM circuit 210a reads the data 57b from the address 7 outputted to the read address 208a by the read address control part 213,
the RAM circuit 210b reads the data 1b from the address 0 outputted to the read address 208b by the read address control part 213,
the RAM circuit 210c reads the data 9b from the address 1 outputted to the read address 208c by the read address control part 213,
the RAM circuit 210d reads the data 17b from the address 2 outputted to the read address 208d by the read address control part 213,
the RAM circuit 210e reads the data 25b from the address 3 outputted to the read address 208e by the read address control part 213,
the RAM circuit 210f reads the data 33b from the address 4 outputted to the read address 208f by the read address control part 213,
the RAM circuit 210g reads the data 41b from the address 5 outputted to the read address 208g by the read address control part 213, and
the RAM circuit 210h reads the data 49b from the address 6 outputted to the read address 208h by the read address control part 213.

In the cycle t18,
the RAM circuit 210a reads the data 50b from the address 6 outputted to the read address 208a by the read address control part 213,
the RAM circuit 210b reads the data 58b from the address 7 outputted to the read address 208b by the read address control part 213,
the RAM circuit 210c reads the data 2b from the address 0 outputted to the read address 208c by the read address control part 213,
the RAM circuit 210d reads the data 10b from the address 1 outputted to the read address 208d by the read address control part 213,
the RAM circuit 210e reads the data 18b from the address 2 outputted to the read address 208e by the read address control part 213,
the RAM circuit 210f reads the data 26b from the address 3 outputted to the read address 208f by the read address control part 213,
the RAM circuit 210g reads the data 34b from the address 4 outputted to the read address line 208g by the read address control part 213, and
the RAM circuit 210h reads the data 42b from the address 5 outputted to the read address 208h by the read address control part 213.

In the cycle t19,
the RAM circuit 210a reads the data 43b from the address 5 outputted to the read address 208a by the read address control part 213,
the RAM circuit 210b reads the data 51b from the address 6 outputted to the read address 208b by the read address control part 213,
the RAM circuit 210c reads the data 59b from the address 7 outputted to the read address 208c by the read address control part 213,
the RAM circuit 210d reads the data 3b from the address 0 outputted to the read address 208d by the read address control part 213,
the RAM circuit 210e reads the data 11b from the address 1 outputted to the read address 208e by the read address control part 213,
the RAM circuit 210f reads the data 19b from the address 2 outputted to the read address 208f by the read address control part 213,
the RAM circuit 210g reads the data 27b from the address 3 outputted to the read address 208g by the read address control part 213, and
the RAM circuit 210h reads the data 35b from the address 4 outputted to the read address 208h by the read address control part 213.

In the cycle t20,
the RAM circuit 210a reads the data 36b from the address 4 outputted to the read address 208a by the read address control part 213,
the RAM circuit 210b reads the data 44b from the address 5 outputted to the read address 208b by the read address control part 213,
the RAM circuit 210c reads the data 52b from the address 6 outputted to the read address 208c by the read address control part 213,
the RAM circuit 210d reads the data 60b from the address 7 outputted to the read address 208d by the read address control part 213,
the RAM circuit 210e reads the data 4b from the address 0 outputted to the read address 208e by the read address control part 213,
the RAM circuit 210f reads the data 12b from the address 1 outputted to the read address 208f by the read address control part 213,
the RAM circuit 210g reads the data 20b from the address 2 outputted to the read address 208g by the read address control part 213, and
the RAM circuit 210h reads the data 28b from the address 3 outputted to the read address 208h by the read address control part 213.

In the cycle t21,
the RAM circuit 210a reads the data 29b from the address 3 outputted to the read address 208a by the read address control part 213,
the RAM circuit 210b reads the data 37b from the address 4 outputted to the read address 208b by the read address control part 213,
the RAM circuit 210c reads the data 45b from the address 5 outputted to the read address 208c by the read address control part 213,
the RAM circuit 210d reads the data 53b from the address 6 outputted to the read address 208d by the read address control part 213,
the RAM circuit 210e reads the data 61b from the address 7 outputted to the read address 208e by the read address control part 213,
the RAM circuit 210f reads the data 5b from the address 0 outputted to the read address 208f by the read address control part 213,
the RAM circuit 210g reads the data 13b from the address 1 outputted to the read address 208g by the read address control part 213, and
the RAM circuit 210h reads the data 21b from the address 2 outputted to the read address 208h by the read address control part 213.

In the cycle t22,
the RAM circuit 210a reads the data 22b from the address 2 outputted to the read address 208a by the read address control part 213,
the RAM circuit 210b reads the data 30b from the address 3 outputted to the read address 208b by the read address control part 213,
the RAM circuit 210c reads the data 38b from the address 4 outputted to the read address 208c by the read address control part 213,
the RAM circuit 210d reads the data 46b from the address 5 outputted to the read address 208d by the read address control part 213,
the RAM circuit 210e reads the data 54b from the address 6 outputted to the read address 208e by the read address control part 213,
the RAM circuit 210f reads the data 62b from the address 7 outputted to the read address 208f by the read address control part 213,
the RAM circuit 210g reads the data 6b from the address 0 outputted to the read address 208g by the read address control part 213, and
the RAM circuit 210h reads the data 14b from the address 1 outputted to the read address 208h by the read address control part 213.

In the cycle t23,
the RAM circuit 210a reads the data 15b from the address 1 outputted to the read address 208a by the read address control part 213,
the RAM circuit 210b reads the data 23b from the address 2 outputted to the read address 208b by the read address control part 213,
the RAM circuit 210c reads the data 31b from the address 3 outputted to the read address 208c by the read address control part 213,
the RAM circuit 210d reads the data 39b from the address 4 outputted to the read address 208d by the read address control part 213,
the RAM circuit 210e reads the data 47b from the address 5 outputted to the read address 208e by the read address control part 213,
the RAM circuit 210f reads the data 55b from the address 6 outputted to the read address 208f by the read address control part 213,
the RAM circuit 210g reads the data 63b from the address 7 outputted to the read address 208g by the read address control part 213, and
the RAM circuit 210h reads the data 7b from the address 0 outputted to the read address 208h by the read address control part 213.

As described above, in the first address order, addresses different from each other are outputted to the read addresses 208a to 208h that specify the read addresses of the RAM circuits 210a to 210h.

In each of the cycles t16 to t23, a different address is outputted to each of the read addresses 208a to 208h. For instance, different addresses, the addresses 0 to 7, are outputted to the read address 208a in the cycles t16 to t23.

The next describes an operation of the second data distribution part 203 in the cycles t8 to t15.

More specifically,
in the cycle t8,
the data 0a received from 206a is outputted to out0,
the data 8a received from 206b is outputted to out1,
the data 16a received from 206c is outputted to out2,
the data 24a received from 206d is outputted to out3,
the data 32a received from 206e is outputted to out4,
the data 40a received from 206f is outputted to out5,
the data 48a received from 206g is outputted to out6, and
the data 56a received from 206h is outputted to out7.

In the cycle t9,
the data 57a received from 206a is outputted to out7,
the data 1a received from 206b is outputted to out0,
the data 9a received from 206c is outputted to out1,
the data 17a received from 206d is outputted to out2,
the data 25a received from 206e is outputted to out3,
the data 33a received from 206f is outputted to out4,
the data 41a received from 206g is outputted to out5, and
the data 49a received from 206h is outputted to out6.

In the cycle t10,
the data 50a received from 206a is outputted to out6,
the data 58a received from 206b is outputted to out7,
the data 2a received from 206c is outputted to out0,
the data 10a received from 206d is outputted to out1,
the data 18a received from 206e is outputted to out2,
the data 26a received from 206f is outputted to out3,
the data 34a received from 206g is outputted to out4, and
the data 42a received from 206h is outputted to out5.

In the cycle t11,
the data 43a received from 206a is outputted to out5,
the data 51a received from 206b is outputted to out6,
the data 59a received from 206c is outputted to out7,
the data 3a received from 206d is outputted to out0,
the data 11a received from 206e is outputted to out1,
the data 19a received from 206f is outputted to out2,
the data 27a received from 206g is outputted to out3, and
the data 35a received from 206h is outputted to out4.

In the cycle t12,
the data 36a received from 206a is outputted to out4,
the data 44a received from 206b is outputted to out5,
the data 52a received from 206c is outputted to out6,
the data 60a received from 206d is outputted to out7,
the data 4a received from 206e is outputted to out0,
the data 12a received from 206f is outputted to out1,
the data 20a received from 206g is outputted to out2, and
the data 28a received from 206h is outputted to out3.

In the cycle t13,
the data 29a received from 206a is outputted to out3,
the data 37a received from 206b is outputted to out4,
the data 45a received from 206c is outputted to out5,
the data 53a received from 206d is outputted to out6,
the data 61a received from 206e is outputted to out7,
the data 5a received from 206f is outputted to out0,
the data 13a received from 206g is outputted to out1, and
the data 21a received from 206h is outputted to out2.

In the cycle t14,
the data 22a received from 206a is outputted to out2,
the data 30a received from 206b is outputted to out3,
the data 38a received from 206c is outputted to out4,
the data 46a received from 206d is outputted to out5,
the data 54a received from 206e is outputted to out6,
the data 62a received from 206f is outputted to out7,
the data 6a received from 206g is outputted to out0, and
the data 14a received from 206h is outputted to out1.

In the cycle t15,
the data 15a received from 206a is outputted to out1,
the data 23a received from 206b is outputted to out2,
the data 31a received from 206c is outputted to out3,
the data 39a received from 206d is outputted to out4,
the data 47a received from 206e is outputted to out5,
the data 55a received from 206f is outputted to out6,
the data 63a received from 206g is outputted to out7, and
the data 7a received from 206h is outputted to out0.

As described above, as a result of the data distribution processing performed by the second data distribution part 203, the data 0a to 63a are outputted to out0 to out7 in the bit-reversed order in the cycles t8 to t15.

As the first data distribution part 202, the second data distribution part 203 performs rotation processing on eight pieces of data simultaneously received in parallel and outputs the results. It may be easily realized by, for example, a shift circuit.

The second data distribution part 203 also performs the same data distribution processing on the data 0b to 63b in the cycles t16 to t23, and the data 0b to 63b are outputted to out0 to out7 in the bit-reversed order.

While the data reordering processing has been described above using an example of reordering from the sequential order to the bit-reversed order, reordering from the bit-reversed order to the sequential order can also be achieved in the same manner.

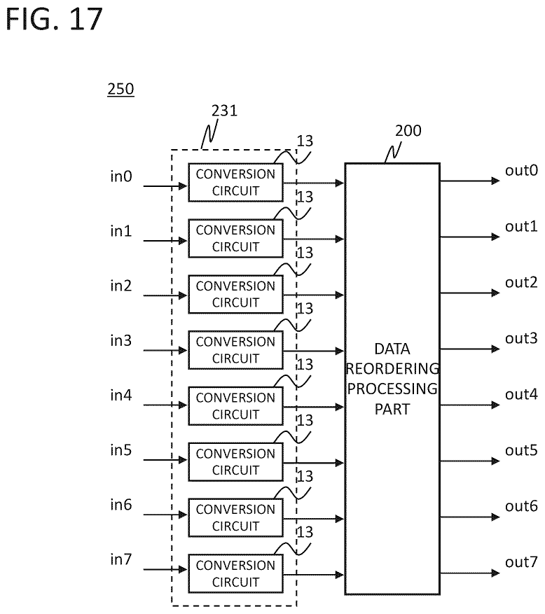

Referring to FIG. 17, a data reordering processing part 250 is constituted by the conversion circuit 231 and the data reordering processing part 200. The data reordering processing part 250 receives supplied signal data represented in the two's complement representation, performs data reordering processing thereon, and outputs a result as signal data represented in the partial sign magnitude—representation.

More specifically, the conversion circuit 231 is configured to convert the supplied signal data represented in two's complement representation to those represented in the partial sign magnitude—representation, and output the result to the data reordering processing part 200.

The data reordering processing part 200 receives the signal data outputted by the conversion circuit 231 and represented in the partial sign magnitude—representation and performs data reordering processing on the signal data while in the partial sign magnitude—representation to output a result while in the partial sign magnitude—representation.

As described above, the FFT apparatus 30 performs FFT processing on supplied signal data represented in the two's complement representation and outputs a result thereof as signal data represented in the partial sign magnitude—representation. Further, although the above has described FFT processing, IFFT processing can also be implemented with a configuration similar to that of the present example embodiment.

As described above, in the present example embodiment, the data reordering processing part 200, which the FFT apparatus 30 includes in the data reordering processing parts 240 and 250, achieves reordering from the “sequential order” to the “bit-reversed order” and reordering from the “bit-reversed order” to the “sequential order,” data reordering processing required in a butterfly operation, by controlling read and write operations of the RAM circuits 210a to 210h using two types of address orders, namely the first and the second address orders. For instance, data written to the RAM circuits in the first address order are read in the second address order, and data written in the second address order are read in the first address order.

As a result, in the present example embodiment, even when FFT processing is performed on signals that are supplied continuously, data reordering processing may be achieved with a RAM circuit having a storage capacity equal to the number of FFT points. Therefore, compared with conventionally known double-buffering, which requires a storage capacity at least twice the number of FFT points for data reordering processing, the present example embodiment reduces the storage capacity of the RAM circuit by half, thereby reducing the circuit scale and power dissipation of the RAM circuit. As a result, the circuit scale and power dissipation of the entire FFT apparatus including the data reordering processing part may be reduced.

In the present example embodiment, the FFT apparatus 30 has the data reordering processing parts 240 and 250 reorder data from the “sequential order” to the “bit-reversed order” or from the “bit-reversed order” to the “sequential order,” which is data reordering processing required in a butterfly operation, after converting the data to the partial sign magnitude—representation. Therefore, as compared with a case where reordering processing is performed while keeping data in the two's complement representation, the percentage-activity of flip-flop circuits and selector circuits constituting the RAM circuits 210a to 210h, the first data distribution part 202, and the second data distribution part 203 may be reduced.

Further, the conversion between the two's complement representation and the partial sign magnitude—representation may be achieved only with bit inversion processing and does not require add-one processing (increment processing) which is required in the case of the conventional sign magnitude representation. Since a bit inversion circuit may be implemented only with an XOR circuit, this may be implemented with an overwhelmingly small circuit scale, as compared with other logic processing circuits and operation processing circuits.

As compared with conversion between the two's complement representation and the partial sign magnitude—representation, the number of required XOR circuits is smaller. As a result, this may be implemented with a smaller circuit scale.

Therefore, in the present example embodiment, even when processing a signal with a value which frequently changes between positive and negative in the vicinity of zero, it is possible to keep the circuit operation rate in data reordering processing to a minimum. As a result, the power dissipation in the data reordering processing part may be reduced.

In the present example embodiment, the butterfly operation processing part and the twiddle factor multiplication processing part perform butterfly operation processing and twiddle factor multiplication processing in the two's complement representation. Therefore, the percentage-activity related to these arithmetic processes is not reduced. The conversion between the data representation formats, however, does not increase the circuit scale unlike in the case where the conventional sign magnitude representation is applied. Therefore, the power dissipation of the entire FFT apparatus may be reduced by the amount of the power dissipation reduced in data reordering processing.

Since the scale of the conversion circuit is smaller, compared to the case where the sign magnitude—representation is used, more conversion processes may be performed in more optimal locations. As a result, the power dissipation of the entire FFT apparatus may be further reduced.

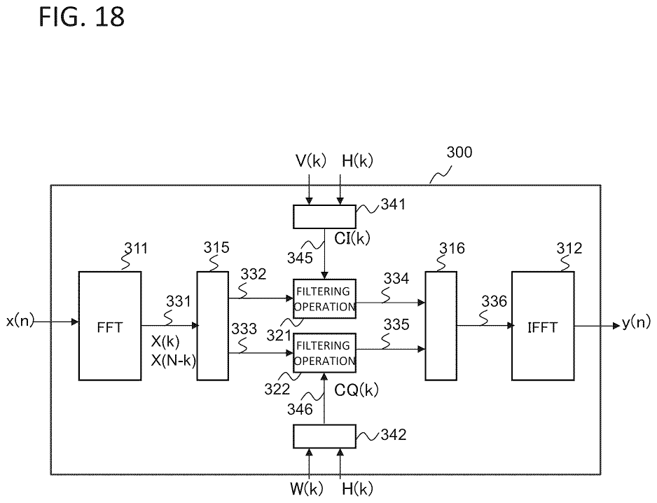

The following describes yet another example embodiment of the present disclosure. FIG. 18 is a diagram illustrating a configuration of a digital filter circuit 300 relating to yet another example embodiment of the present disclosure. Referring to FIG. 18, the digital filter circuit 300 includes an FFT circuit 311, an IFFT circuit 312, an IQ separation circuit (IQ separator) 315, an IQ combining circuit (IQ combiner) 316, filter circuits 321 and 322, and filter coefficient generation circuits 341 and 342.

The FFT circuit 311 and the IFFT circuit 312 included in the digital filter circuit 300 may be implemented by using the FFT apparatus 30 of FIG. 7 described as an example embodiment of the present disclosure. Accordingly, the FFT circuit 311 performs FFT processing on supplied signal data represented in the two's complement representation to output a result thereof as signal data represented in the partial sign magnitude—representation. Similarly, the IFFT circuit 312 performs IFFT processing on supplied signal data represented in the two's complement representation to output a result thereof as signal data represented in the partial sign magnitude—representation.

The digital filter circuit 300 receives a time-domain complex-valued signal:

x(n)=r(n)+js(n) (2).

When x(t) is sampled with a sampling period of time Ts, sampled values (sampled time series values) are (x(0), x(Ts), x(2Ts), . . . ), where information of the sampling period of time Ts is omitted, the time axis is expressed by an integer n, and the sampled value at a time nTs is denoted as x(n). In Equation (2), r(n) is a real part of x(n), and s(n) an imaginary part of x(n) (j²=−1). The symbol n denotes a sample index number in time domain (0≤n≤N−1, where N is a positive integer corresponding to the number of points in the FFT/IFFT).

The FFT circuit 311 converts the complex-valued signal x(n) received to a frequency-domain complex-valued signal:

X(k)=A(k)+jB(k) (3)

### by FFT.

Here, k is a non-negative integer indicating a frequency index in frequency domain (0≤k≤N−1).

Further, the FFT circuit 311 generates:

X(N−k)=A(N−k)+jB(N−k) (4)

from X(k) and outputs it.

The IQ separation circuit 315 receives X(N−k) outputted by the FFT circuit 311 for each frequency index k (0≤k≤N−1) and generates a complex conjugate of X(N−k):

X*(N−k)=A(N−k)−jB(N−k) (5).

The IQ separation circuit 315 further generates an I-component signal:

XI(k)={X(k)+X*(N−k)}/2={A(k)+A(N−k)}/2+j{B(k)+B(N−k)}/2 (6)

and a Q-component signal:

XQ(k)={X(k)−X*(N−k)}/2={A(k)−A(N−k)}/2+j{B(k)+B(N−k)}/2 (7).

The IQ separation circuit 315 outputs the generated I-component signal XI(k) as an I-component signal 332 and outputs the generated Q-component signal XQ(k) as a Q-component signal 333.

Next, the filter coefficient generation circuit 341 generates, for each frequency index k (0≤k≤N−1), a complex-valued coefficient:

CI(k)=V(k)×H(k) (8)

from supplied complex-valued coefficients V(k) and H(k).

Next, the filter coefficient generation circuit 342 generates, for each frequency index k (0≤k≤N−1), a complex-valued coefficient:

CQ(k)=W(k)×H(k) (9)

from supplied complex-valued coefficients W(k) and H(k).

Here, the complex-valued coefficients V(k), W(k), and H(k) are frequency-domain coefficients supplied by an upper-level circuit (not shown in the drawing) of the digital filter circuit 300 and correspond to real-valued filter coefficients in a case where filter processing is performed by using real-number operations in time domain.

The filter coefficient generation circuit 341 outputs the generated complex-valued coefficient CI(k) as a complex-valued signal 345. The filter coefficient generation circuit 342 outputs the generated complex-valued coefficient CQ(k) as a complex-valued signal 346.

Next, the filter circuit 321 performs complex-valued filter processing using complex multiplication on XI(k) (Equation (6)) outputted as the I-component signal 332 from the IQ separation circuit 315, using CI(k) (Equation (8)) outputted as the complex-valued signal 345 from the filter coefficient generation circuit 341. More specifically, the filter circuit 321 performs the following operation (Equation (10)) for each frequency index k (0≤k≤N−1) and outputs XI′(k) as a complex-valued signal 334.

XI′(k)=XI(k)×CI(k) (10)

Likewise, the filter circuit 322 performs complex-valued filter processing using complex multiplication on XQ(k) (Equation (7)) outputted as the Q-component signal 333 from the IQ separation circuit 315, using CQ(k) (Equation (9)) outputted as the complex-valued signal 346 from the filter coefficient generation circuit 342. More specifically, the filter circuit 322 performs the following operation (Equation (11)) for each frequency index k (0≤k≤N−1) and outputs XQ′(k) as a complex-valued signal 335.

XQ′(k)=XQ(k)×CQ(k) (11)

CI(k) and CQ(k) can each be separated into a real part and an imaginary part and expressed as

CI(k)=CII(k)+jCIQ(k) (12)

CQ(k)=CQI(k)+jCQQ(k) (13).

Next, the IQ combining circuit 316 generates a complex-valued signal X″(k) obtained by combining XI′(k) (Equation (10)) outputted as the complex-valued signal 334 from the filter circuit 321 and XQ′(k) (Equation (11)) outputted as the complex-valued signal 335 from the filter circuit 322. More specifically, the IQ combining circuit 316 performs the following operation (Equation (14)) for each frequency index k (0≤k≤N−1) and outputs X″(k) as a complex-valued signal 336.

X″(k)=XI′(k)+XQ′(k) (14)

Next, the IFFT circuit 312 generates and outputs a time-domain complex-valued signal y(n) by IFFT on X″(k) (Equation (14)) outputted as the complex-valued signal 336 from the IQ combining circuit 316 for each frequency index k (0≤k≤N−1).

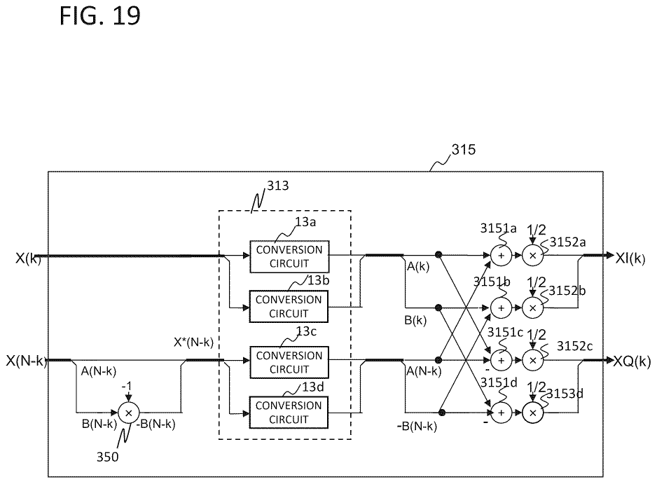

FIG. 19 is a diagram illustrating a configuration example of the IQ separation circuit 315 of the digital filter circuit 300 in FIG. 18. Referring to FIG. 19, the IQ separation circuit 315 receives the output X(k) (=A(k)+jB(k); Equation (3)) represented in the partial sign magnitude—representation and outputted by the FFT circuit 311, also receives the output X(N−k) (=A(N−k)+jB(N−k); Equation (4)) represented in the partial sign magnitude—representation, and computes the complex conjugate signal X*(N−k) in the partial sign magnitude—representation.

X*(N−k)=A(N−k)−jB(N−k) (5)

More specifically, a multiplication circuit 350 multiplies the imaginary part B(N−k) of the frequency-domain complex-valued signal X*(N−k) represented in the partial sign magnitude—representation by a multiplier of −1 in the partial sign magnitude—representation to output −B(N−k).

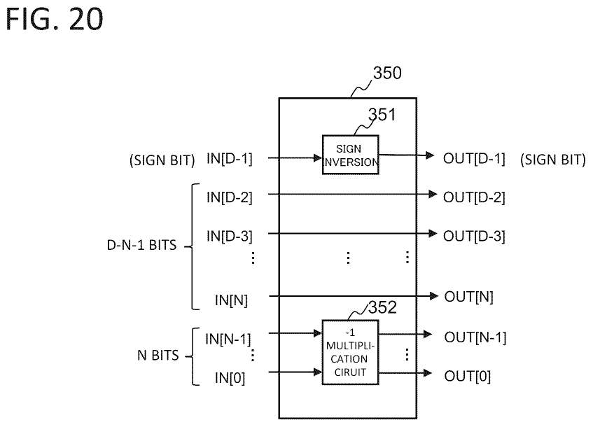

FIG. 20 is a diagram illustrating a configuration example of the multiplication circuit 350 of FIG. 19. Referring to FIG. 20, the multiplication circuit 350 is configured to receive, in parallel, D-bits signal data (IN[0] to IN[D−1]) (where D is a positive integer greater than or equal to three) represented in the partial sign magnitude—representation, and perform multiplication using the multiplier of −1 in the partial sign magnitude—representation, to output, in parallel, D bits (OUT[0] to OUT[D−1]).

More specifically, the multiplication circuit 350 inverts a sign of a most significant bit indicating a sign of the signal data, received from the input IN[D−1], using a sign inversion circuit 351 and outputs a result to OUT[D−1].

A −1 multiplication circuit 352 multiplies N consecutive lower bits including a least significant bit, received from the inputs IN[0] to IN[N−1], by −1 (i.e., by a multiplier of −1) and outputs each result to the outputs OUT[0] to OUT[N−1], respectively.

Remaining consecutive (D−N−1) bits received from the inputs IN[N] to IN[D−2] (with the most significant bit and the N consecutive lower bits excluded) are outputted, as they are, to the outputs OUT[N] to OUT[D−2], respectively.

The sign inversion circuit 351 may be implemented by a NOT circuit. Further, since the N consecutive lower bits including the least significant bit, received from the inputs IN[0] to IN[N−1], in the partial sign magnitude—representation have the same bit values as those in the two's complement representation, the −1 multiplication circuit 352 may be implemented with a configuration identical to that of a multiplication circuit in the two's complement representation.

Through the processes described above, the multiplication circuit 350 performs multiplication of the signal data by the multiplier −1 in the partial sign magnitude—representation.

A conversion circuit 313 included in the IQ separation circuit 315 shown in FIG. 19 converts the supplied X(k) represented in the partial sign magnitude—representation and the calculated X*(N−k) represented in the partial sign magnitude—representation to the two's complement representation. The conversion circuit 313 may be constituted by four conversion circuits 13 (FIG. 4), respectively corresponding to the real part A(k) and the imaginary part B(k) of X(k), and the real part A(N−k) and the imaginary part B(N−k) of X*(N−k).

Next, the IQ separation circuit 315 generates the I-component signal XI(k) and the Q-component signal XQ(k) from A(k), B(k), A(N−k), and B(N−k) converted to the two's complement representation by the conversion circuits 313a to 313d and outputs them.

XI(k)={X(k)+X*(N−k)}/2={A(k)+A(N−k)}/2+j{B(k)−B(N−k)}/2 (6)

XQ(k)={X(k)−X*(N−k)}/2={A(k)−A(N−k)}/2+j{B(k)+B(N−k)}/2 (7)

In FIG. 19, an adder 3151a receives A(k) and A(M−k) and outputs A(k)+A(M−k) to a multiplier 3152a, and the multiplier 3152a outputs (1/2)×{A(k)+A(M−k)}.
An adder 3151b receives B(k) and −B(M−k) and outputs B(k)+B(M−k) to a multiplier 3152b, and the multiplier 3152b outputs (1/2)×{B(k)−B(M−k)}.
An adder 3151c receives A(k) and −A(M−k) and outputs A(k)−A(M−k) to the multiplier 3152a, and the multiplier 3152a outputs (1/2)×{A(k)−A(M−k)}.
An adder 3151d receives B(k) and −B(M−k) and outputs B(k)+B(M−k) to the multiplier 3152b, and the multiplier 3152b outputs (1/2)×{B(k)+B(M−k)}.

Note that XI(k) and XQ(k) can each be separated into a real part and an imaginary part and expressed as:

XI(k)=XII(k)+jXIQ(k) (15)

XQ(k)=XQI(k)+jXQQ(k) (16).

XII(k) is an output of the multiplier 3152a, XIQ(k) is an output of the multiplier 3152b, XQI(k) is an output of the multiplier 3152c, and XQQ(k) is an output of the multiplier 3152d.

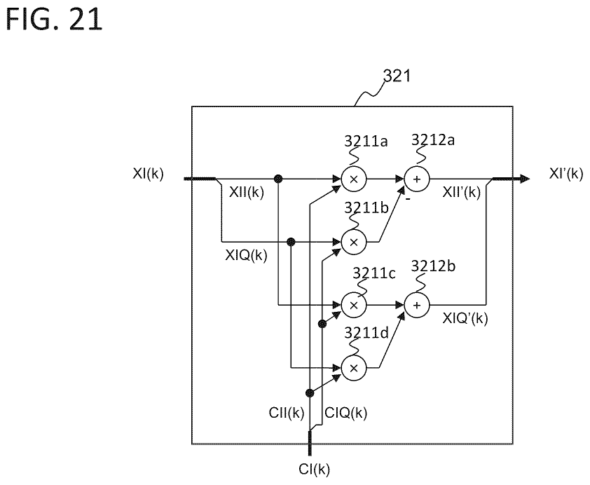

FIG. 21 is a diagram illustrating a configuration example of the filter circuit 321 of FIG. 18. Referring to FIG. 21, the filter circuit 321 receives XI(k) (=XII(k)+jXIQ(k); Equation (15)) outputted as the I-component signal 332 by the IQ separation circuit 315, and the complex-valued coefficient CI(k) (=CII(k)+jCIQ(k); Equation (12)), and performs the following operation Equation (17) to output XI′(k):

XI′(k)=XII′(k)+jXIQ′(k)=XI(k)×CI(k) (17)

Here, XII′(k) and XIQ′(k) are a real part and an imaginary part of XI′(k), respectively, and are given by the following Equations (18) and (19):

XII′(k)=XII(k)×CII(k)−XIQ(k)×CIQ(k) (18)

XIQ′(k)=XII(k)×CIQ(k)+XIQ(k)×CII(k) (19)

In FIG. 21, a multiplier 3211a outputs the product XII(k)×CII(k) of XII(k) and CII(k) to an adder 3212a, a multiplier 3211b outputs the product XIQ(k)×CIQ(k) of XIQ(k) and CIQ(k) to the adder 3212a, and the adder 3212a adds XII(k)×CII(k) and −XIQ(k)×CIQ(k), and outputs XII(k)×CII(k)−XIQ(k)×CIQ(k) as the real part XII′(k) of XI′(k).

A multiplier 3211c outputs the product XII(k)×CIQ(k) of XII(k) and CIQ(k) to an adder 3212b, a multiplier 3211d outputs the product XIQ(k)×CII(k) of XIQ(k) and CII(k) to the adder 3212b, and the adder 3212b outputs XII(k)×CIQ(k)+XIQ(k)×CII(k) as the imaginary part XIQ′(k) of XI′(k).

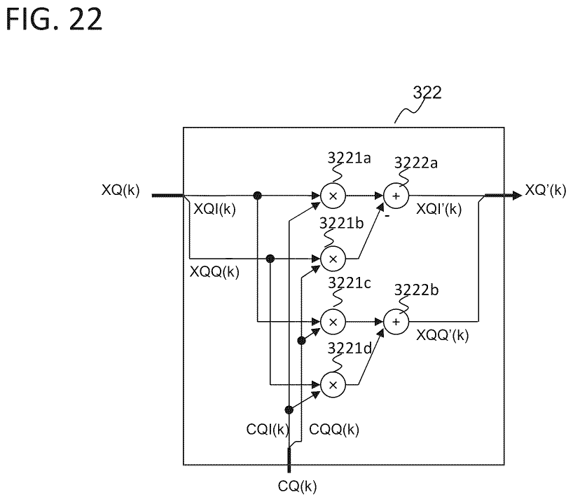

FIG. 22 is a diagram illustrating a configuration example of the filter circuit 322 of FIG. 18. Referring to FIG. 22, the filter circuit 322 receives XQ(k) (=XQI(k)+jXQQ(k); Equation (16)) outputted as the Q-component signal 333 by the IQ separation circuit 315, and the complex-valued coefficient CQ(k) (=CQI(k)+jCQQ(k); Equation (13)), and performs the following operation Equation (20) to output XQ′(k):

XQ′(k)=XQI′(k)+jXQQ′(k)=XQ(k)×CQ(k) (20)

Here, XQI′(k) and XQQ′(k) are a real part and an imaginary part of XQ′(k), respectively, and are given by the following Equations (21) and (22):

XQI′(k)=XQI(k)×CQI(k)−XQQ(k)×CQQ(k) (21)

XQQ′(k)=XQI(k)×CQQ(k)+XQQ(k)×CQI(k) (22)

In FIG. 22, a multiplier 3221a outputs the product XQI(k)×CQI(k) of XQI(k) and CQI(k) to an adder 3222a, a multiplier 3221b outputs the product XIQ(k)×CIQ(k) of XIQ(k) and CIQ(k) to the adder 3222a, and the adder 3222a adds XQI(k)×CQI(k) and −XQQ(k)×CQQ(k), and outputs XQI(k)×CQI(k)−XQQ(k)×CQQ(k) as the real part XQI′(k) of XQ′(k).

A multiplier 3221c outputs the product XQI(k)×CQQ(k) of XQI(k) and CQQ(k) to an adder 3222b, a multiplier 3221d outputs the product XQQ(k)×CQI(k) of XQQ(k) and CQI(k) to the adder 3222b, and the adder 3222b outputs XQI(k)×CQQ(k)+XIQ(k)×CII(k) as the imaginary part XQQ′(k) of XQ′(k).

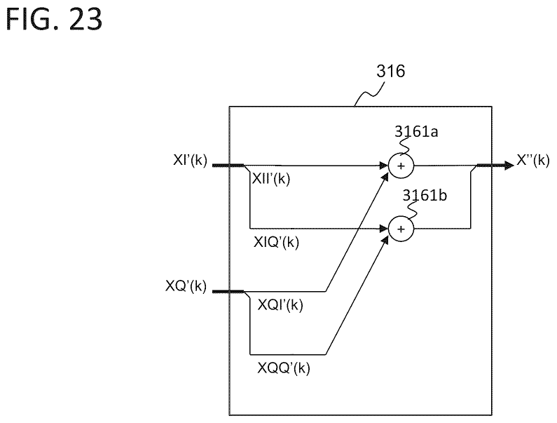

FIG. 23 is a diagram illustrating a configuration example of the IQ combining circuit 316. Referring to FIG. 23, for each frequency index k (0≤k≤N−1), the IQ combining circuit 316 receives XI′(k) (=XII′(k)+jXIQ′(k); Equation (17)) outputted as the complex-valued signal 334 (FIG. 18) by the filter circuit 321 and XQ′(k) (=XQI′(k)+jXQQ′(k); Equation (20)) outputted as the complex-valued signal 335 (FIG. 18) by the filter circuit 322, combines XI′(k) and XQ′(k) to generate the complex-valued signal X″(k) using the following Equation (23), and outputs it as the complex-valued signal 336 (FIG. 18):

X″(k)=XI″(k)+jXQ″(k)=XI′(k)+XQ′(k)=XII′(k)+XQI′(k)+j(XIQ′(k)+XQQ′(k)) (23)

In FIG. 23, an adder 3161a receives the real part XII′(k) of XI′(k) and the real part XQI′(k) of XQ′(k), and outputs XII′(k)+XQI′(k) as a real part XI′(k) of X″(k). An adder 3161b receives the imaginary part XIQ′(k) of XI′(k) and the imaginary part XQQ′(k) of XQ′(k), and outputs XIQ′(k)+XQQ′(k) as an imaginary part XQ′(k) of X″(k).

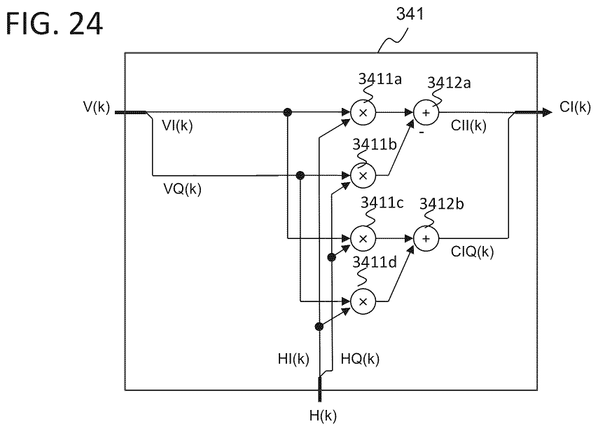

The filter coefficient generation circuit 341 generates the complex-valued coefficient CI(k) used by the filter circuit 321. FIG. 24 is a diagram illustrating a configuration example of the filter coefficient generation circuit 341. Referring to FIG. 24, for each frequency index k (0≤k≤N−1), the filter coefficient generation circuit 341 computes the complex-valued coefficient CI(k) defined by the following Equation (24) from the complex-valued coefficients V(k) and H(k) supplied by an upper-level circuit (not shown in the drawing) and outputs it:

CI(k)=CII(k)+jCIQ(k)=V(k)×H(k) (24)

Here, CII(k) and CIQ(k) are the real part and the imaginary part of CI(k), respectively.

V(k) and H(k) can also be separated into a real part and an imaginary part and expressed as:

V(k)=VI(k)+jVQ(k) (25)

H(k)=HI(k)+jHQ(k) (26).

Plugging Equations (25) and (26) into Equation (24),

CI(k)={VI(k)+jVQ(k)}×{HI(k)+jHQ(k)} (27).

Accordingly,

CI(k)=VI(k)×HI(k)−VQ(k)×HQ(k)+j{VI(k)×HQ(k)+VQ(k)×HI(k)},

and thus,

CII(k)=VI(k)×HI(k)−VQ(k)×HQ(k) (28)

CIQ(k)=VQ(k)×HI(k)+VI(k)×HQ(k) (29).

In FIG. 24, a multiplier 3411a outputs the product VI(k)×HI(k) of VI(k) and HI(k) to an adder 3412a, a multiplier 3411b outputs the product VQ(k)×HQ(k) of VQ(k) and HQ(k) to the adder 3412a, and the adder 3412a adds VI(k)×HI(k) and −VQ(k)×HQ(k) and outputs VI(k)×HI(k)−VQ(k)×HQ(k) as the real part CII(k) of CI(k).

A multiplier 3411c outputs the product VI(k)×HQ(k) of VI(k) and HQ(k) to an adder 3412b, a multiplier 3411d outputs the product VQ(k)×HI(k) of VQ(k) and HI(k) to the adder 3412b, and the adder 3412b outputs VI(k)×HQ(k)+VQ(k)×HI(k) as the imaginary part CIQ(k) of CI(k).

The filter coefficient generation circuit 342 generates the complex-valued coefficient CQ(k) used by the filter circuit 322.

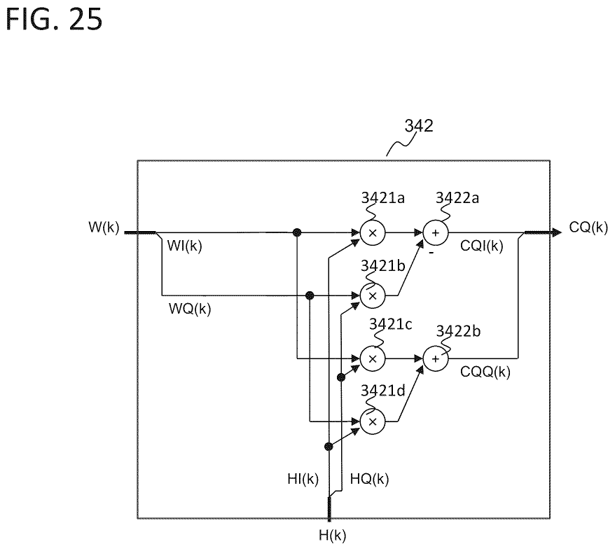

FIG. 25 is a diagram illustrating a configuration example of the filter coefficient generation circuit 342. Referring to FIG. 25, for each frequency index k (0≤k≤N−1), the filter coefficient generation circuit 342 computes the complex-valued coefficient CQ(k) defined by the following Equation (30) from the complex-valued coefficients W(k) and H(k) supplied from an upper-level circuit (not shown in the drawing) and outputs it:

CQ(k)=CQI(k)+jCQQ(k)=W(k)×H(k) (30)

Here, CQI(k) and CQQ(k) are the real part and the imaginary part of CQ(k), respectively.

W(k) can also be separated into a real part and an imaginary part and expressed as:

W(k)=WI(k)+jWQ(k) (31).

Plugging Equations (31) and (26) into Equation (30),

CQ(k)={WI(k)+jQQ(k)}×{HI(k)+jHQ(k)} (32).

Accordingly,

CQ(k)=WI(k)×HI(k)−WQ(k)×HQ(k)+j{WI(k)×HQ(k)+WQ(k)×HI(k)},

and thus,

CQI(k)=WI(k)×HI(k)−WQ(k)×HQ(k) (33)

CQQ(k)=WQ(k)×HI(k)+WI(k)×HQ(k) (34).

In FIG. 25, a multiplier 3421a outputs the product WI(k)×HI(k) of WI(k) and HI(k) to an adder 3422a, a multiplier 3421b outputs the product WQ(k)×HQ(k) of WQ(k) and HQ(k) to the adder 3422a, and the adder 3422a adds WI(k)×HI(k) and −WQ(k)×HQ(k), and outputs WI(k)×HI(k)−WQ(k)×HQ(k) as the real part CQ(k) of CQ(k).
A multiplier 3421c outputs the product WI(k)×HQ(k) of WI(k) and HQ(k) to an adder 3422b, a multiplier 3421d outputs the product WQ(k)×HI(k) of WQ(k) and HI(k) to the adder 3422b, and the adder 3422b outputs WI(k)×HQ(k)+WQ(k)×HI(k) as the imaginary part CQQ(k) of CQ(k).

As described above, the digital filter circuit 300 performs FFT conversion on a time-domain input signal to generate a frequency-domain complex-valued signal. The digital filter circuit 300 then separates the frequency-domain complex-valued signal into an I-component signal and a Q-component signal, independently performs filter processing on each using two types of coefficients generated from V(k), W(k), and H(k), and converts results thereof into a time-domain signal by IFFT.

As described above, according to the present example embodiment, filter processing is performed using two types of frequency-domain filter coefficients corresponding to time-domain filter coefficients for a real part and an imaginary part of a complex-valued signal, and a frequency-domain coefficient corresponding to a time-domain filter coefficient for the complex-valued signal. In other words, frequency-domain filter processing is performed corresponding to independent filter processing using a real number operation(s) on each of the real part and the imaginary part of the time-domain complex-valued signal and filter processing using a complex number operation(s) on the time-domain complex-valued signal.

Therefore, desired filter processing may be implemented using only a single FFT circuit that performs FFT prior to the filter processing and a single IFFT circuit that performs IFFT after the filter processing. As a result, there is an effect that a circuit scale and power dissipation required for performing filter processing may be reduced.

According to the present example embodiment, the FFT circuit 311 and the IFFT circuit 312 perform data reordering processing in the partial sign magnitude—representation. Therefore, the percentage-activity of the data reordering circuits may be reduced, compared with a case where the reordering processing takes place without converting the two's complement representation. In addition, according to the present example embodiment, multiplication processing with a multiplier of −1 required for separation of a frequency-domain complex-valued signal into an I-component signal and a Q-component signal is performed in the partial sign magnitude—representation. Accordingly, compared with a case where the multiplication processing is performed in the two's complement representation, the percentage-activity of the multiplication circuit 350 included in the IQ separation circuit 315 may be reduced. Therefore, in the present example embodiment, power dissipation required for performing digital filter processing may be reduced.
[Reference Literature 1] JP-H08-137832A (pp. 3-5, FIG. 25)
[Reference Literature 2] J. W. Cooley, J. W. Tukey, “An Algorithm for the Machine Calculation of Complex Fourier Series,” Mathematics of Computation, US, American Mathematical Society, April 1965, Vol. 19, No. 90, pp. 297-301
[Reference Literature 3] D. P. Kolba, “A Prime Factor FFT Algorithm Using High-Speed Convolution,” IEEE Trans. on Acoustics, US, IEEE Signal Processing Society, August 1977, Vol. 29, No. 4, pp. 281-294
[Reference Literature 4] JP2001-56806A (p. 5, FIG. 1)

The several example embodiments above may be described as (but not limited to) the following Supplementary Notes (abbreviated as Notes).

(Note 1) A signal processing apparatus includes a first operation processing part configured to perform operation processing on data represented in a two's complement representation; a second operation processing part configured to include a multiplication process to multiply, by a multiplier of −1, data represented in a second representation format as a data representation format; and a storage processing part configured to perform storage processing on data represented in the second representation format, wherein the second representation format of the data of D-bits (where D is a positive integer greater than or equal to three), while for the data of a non-negative value being identical to the two's complement representation therefor, for the data of a negative value has a representation format in which (D−N−1) bits (where N is a positive integer such that N≤D−2) represented in the two's complement representation are bit-wise inverted, wherein the (D−N−1) bits are bits obtained by excluding, from the data of D-bits, a most significant bit indicating a sign and N consecutive lower bits including a least significant bit, and wherein the second operation processing part, as the multiplication process by the multiplier of −1, bit-inverts the most significant bit indicating the sign and multiplies the N consecutive lower bits including the least significant bit (where N is a positive integer such that N≤D−2) by −1 for the data of D-bits represented in the second representation format.
(Note 2) A signal processing apparatus includes a first conversion part configured to convert a data representation format of a first complex-valued signal in frequency domain from a two's complement representation to a second representation format for output, the first complex-valued signal in frequency domain obtained by Fourier transform applied on a time-domain complex-valued signal received;
an IQ separator configured to separate the first complex-valued signal into a second complex-valued signal in frequency domain corresponding to a real part of the time-domain complex-valued signal, and a third complex-valued signal in frequency domain corresponding to an imaginary part of the time-domain complex-valued signal, and output the separated signals;
a first filter coefficient generation part configured to receive a first input filter coefficient and a third input filter coefficient and generate a first frequency-domain complex-valued filter coefficient using the first input filter coefficient and the third input filter coefficient;
a second filter coefficient generation part configured to receive a second input filter coefficient and the third input filter coefficient and generate a second frequency-domain complex-valued filter coefficient using the second input filter coefficient and the third input filter coefficient;
a first filter part configured to perform filter processing on the second complex-valued signal using the first frequency-domain filter coefficient to output a fourth complex-valued signal;
a second filter part configured to perform filter processing on the third complex-valued signal using the second frequency-domain filter coefficient to output a fifth complex-valued signal;
an IQ combiner configured to generate a sixth complex-valued signal by combining the fourth complex-valued signal and the fifth complex-valued signal.

The IQ separator includes a multiplication circuit to multiply, by a multiplier of −1, data of D-bits (where D is a positive integer greater than or equal to three) represented in the second representation format. The second representation format, while for a non-negative data value being identical to the two's complement representation therefor, for a negative data value, has a representation format in which (D−N−1) bits (where N is a positive integer such that N≤D−2) represented in the two's complement representation are bit-wise inverted, wherein the (D−N−1) bits are bits obtained by excluding, from the data of D-bits, a most significant bit indicating a sign and N consecutive lower bits including a least significant bit.

The multiplication circuit of the IQ separator, as multiplication by the multiplier of −1, bit-inverts the most significant bit indicating the sign and multiplies the N consecutive lower bits including the least significant bit (where N is a positive integer such that N≤D−2) by −1 for the data represented in the second representation format.

(Note 3) In the signal processing apparatus according to Note 2, the IQ separator is configured to obtain a complex conjugate signal of the first complex-valued signal while kept in the second representation format by performing the multiplication process by the multiplier of −1 on data of an imaginary part of the first complex-valued signal represented in the second representation format, convert data of a real part and an imaginary part of the complex conjugate signal represented in the second representation format to the two's complement representation, and separate the first complex-valued signal represented in the second representation format into the second complex-valued signal and the third complex-valued signal represented in the two's complement representation for output.
(Note 4) In the signal processing apparatus according to Note 2 or 3, an output part (inverse Fourier transform circuit) configured to receive the sixth complex-valued signal in frequency domain represented in the two's complement representation outputted from the IQ combiner; and apply inverse Fourier transform thereon to obtain the sixth complex-valued signal in time domain for output, as an output signal.
(Note 5) In the signal processing apparatus according to Note 1, the storage processing part includes a data reordering processing part configured to rearrange an order of a plurality of pieces of data supplied in a first order to a second order, and the data reordering processing part includes a storage circuit; a first control part configured to write a plurality of pieces of data to the storage circuit in accordance with one of a first address order and a second address order; and a second control part configured to read, from the storage circuit, the plurality of pieces of data that have been written to the storage circuit in accordance with the one of the first address order and the second address order, in accordance with other of the first address order and the second address order.
(Note 6) In the signal processing apparatus according to Note 5, the storage circuit includes a plurality of storage elements configured to store the plurality of pieces of data for each of a plurality of cycles, a plurality of addresses simultaneously supplied to the plurality of storage elements are different from each other in the first address order, and a plurality of addresses simultaneously supplied to the plurality of storage elements are identical to each other in the second address order.
(Note 7) In the signal processing apparatus according to Note 5, the first operation processing part includes a butterfly operation processing part configured to perform butterfly operation processing; and a twiddle factor multiplication processing part configured to perform twiddle factor multiplication processing, the storage processing part further includes a first conversion part configured to receive a plurality of pieces of data represented in the two's complement representation and convert the received plurality of pieces of data represented in the two's complement representation to a plurality of pieces of data represented in the second representation format for output; and a first data distribution part configured to receive the plurality of pieces of data represented in the second representation format outputted from the first conversion part and perform data distribution processing on the plurality of pieces of data received, the plurality of pieces of data represented in the second representation format distributed by the first data distribution part are written to the plurality of storage elements using addresses outputted from the first control part, and the storage processing part further includes a second data distribution part configured to receive the plurality of pieces of data represented in the second representation format read from the plurality of storage elements using addresses outputted from the second control part and perform data distribution processing on the plurality of pieces of data received; and a second conversion part configured to receive the plurality of pieces of data represented in the second representation format distributed by the second data distribution part and convert the received plurality of pieces of data represented in the second representation format to a plurality of pieces of data represented in the two's complement representation for output.
(Note 8) A signal processing apparatus includes a multiplication circuit configured to receive data of D-bits (where D is a positive integer greater than or equal to three) represented in a second representation format as a data representation format and multiply the data by −1, wherein the second representation format, while for a non-negative data value being identical to a two's complement representation therefor, for a negative data value has a representation format in which (D−N−1) bits (where N is a positive integer such that N≤D−2) represented in the two's complement representation are bit-wise inverted, wherein the (D−N−1) bits are bits obtained by excluding, from the data of D-bits, a most significant bit indicating a sign and N consecutive lower bits including a least significant bit, wherein the N consecutive lower bits including the least significant bit represented in the second representation format are identical to the N consecutive lower bits including the least significant bit represented in the two's complement representation, and wherein the multiplication circuit includes a sign inversion circuit configured to bit-invert the most significant bit indicating the sign of the data represented in the second representation format; and a −1 multiplication circuit configured to multiply the N consecutive lower bits including the least significant bit of the data represented in the second representation format (where N is a positive integer such that N≤D−2) by −1.
(Note 9) The signal processing apparatus according to Note 8 includes a conversion circuit configured to receive one of the data of D-bits represented in the second representation format and the data of D-bits represented in the two's complement representation, and convert the received data to data represented in other representation format for output. The conversion circuit includes a circuit(s) configured to output a most significant bit of the data of D-bits received, as it is, as a most significant bit of the data of D-bits represented in the converted, other representation format; output N consecutive lower bits including a least significant bit of the data of D-bits received (where N is a positive integer such that N≤D−2), as they are, as the N consecutive lower bits including a least significant bit of the data of D-bits represented in the converted, other representation format; for (D−N−1) bits obtained by excluding the most significant bit and the N consecutive lower bits including the least significant bit of the data of D-bits received, when a sign indicated by the most significant bit of the data of D-bits received indicates a negative value, output values obtained by bit-wise inverting each of the (D−N−1) bits of the data of D-bits received as the (D−N−1) bits obtained by excluding the most significant bit and the N consecutive lower bits including the least significant bit of data of D-bits represented in the converted, other representation format; and when the sign indicated by the most significant bit of the data of D-bits received indicates a non-negative value, output the (D−N−1) bits of the data of D-bits received, as they are, as the (D−N−1) bits obtained by excluding the most significant bit and the N consecutive lower bits including the least significant bit of the data of D-bits represented in the converted, other representation format.
(Note 10) A signal processing method, processing signal data represented in a second representation format as a data representation format, wherein the signal data is data of D-bits (where D is a positive integer greater than or equal to three), wherein the second representation format, while for a non-negative data value being identical to a two's complement representation therefor, for a negative data value has a representation format in which (D−N−1) bits (where N is a positive integer such that N≤D−2) represented in the two's complement representation are bit-wise inverted, wherein the (D−N−1) bits are bits obtained by excluding, from the data of D-bits, a most significant bit indicating a sign and N consecutive lower bits including a least significant bit, and wherein the N consecutive lower bits including the least significant bit represented in the second representation format are identical to the N consecutive lower bits including the least significant bit represented in the two's complement representation, the signal processing method comprising, when receiving the data represented in the second representation format and multiplying the data by −1, bit-inverting the most significant bit indicating the sign of the data represented in the second representation format; and multiplying the N consecutive lower bits including the least significant bit of the data represented in the second representation format (where N is a positive integer such that N≤D−2) by −1.

Each disclosure of Patent Literature 1 and Reference Literatures 1 to 4 cited above is incorporated herein in its entirety by reference thereto. It is to be noted that it is possible to modify or adjust the example embodiments or examples within the scope of the entirety of the present disclosure (including the claims) and based on the basic technical concept thereof. Further, it is possible to variously combine or select a wide variety of the disclosed elements (including the individual elements of the individual claims, the individual elements of the individual examples, and the individual elements of the individual figures) within the scope of the claims. That is, it is self-explanatory that the present disclosure includes any types of variations and modifications to be done by a person skilled in the art according to the whole disclosure, and the technical concept of the present disclosure.

What is claimed is:

1. A signal processing apparatus comprising:
a first operation processing part configured to perform operation processing on data represented in a two's complement representation;
a second operation processing part configured to include a multiplication operation to multiply, by a multiplier of −1, data represented in a second representation format as a data representation format; and
a storage processing part configured to perform storage processing on data represented in the second representation format,
wherein the second representation format of the data of D-bits (where D is a positive integer greater than or equal to three), while for the data of a non-negative value being identical to the two's complement representation therefor, for the data of a negative value, has a representation format in which (D−N−1) bits (where N is a positive integer such that N≤D−2) represented in the two's complement representation are bit-wise inverted, wherein the (D−N−1) bits are bits obtained by excluding, from the data of D-bits, a most significant bit indicating a sign and N consecutive lower bits including a least significant bit, and
wherein the second operation processing part, as the multiplication process by the multiplier of −1, bit-inverts the most significant bit indicating the sign and multiplies the N consecutive lower bits including the least significant bit (where N is a positive integer such that N≤D−2) by −1 for the data of D-bits represented in the second representation format.

2. A signal processing apparatus comprising:
a first conversion part configured to convert a data representation format of a first complex-valued signal in frequency domain from a two's complement representation to a second representation format for output, the first complex-valued signal in frequency domain obtained by Fourier transform applied on a time-domain complex-valued signal received;
an IQ separator configured to separate the first complex-valued signal into a second complex-valued signal in frequency domain corresponding to a real part of the time-domain complex-valued signal, and a third complex-valued signal in frequency domain corresponding to an imaginary part of the time-domain complex-valued signal, and output the separated signals;
a first filter coefficient generation part configured to receive a first input filter coefficient and a third input filter coefficient and generate a first frequency-domain complex-valued filter coefficient using the first input filter coefficient and the third input filter coefficient;
a second filter coefficient generation part configured to receive a second input filter coefficient and the third input filter coefficient and generate a second frequency-domain complex-valued filter coefficient using the second input filter coefficient and the third input filter coefficient;
a first filter part configured to perform filter processing on the second complex-valued signal using the first frequency-domain filter coefficient to output a fourth complex-valued signal;
a second filter part configured to perform filter processing on the third complex-valued signal using the second frequency-domain filter coefficient to output a fifth complex-valued signal; and
an IQ combiner configured to generate a sixth complex-valued signal by combining the fourth complex-valued signal and the fifth complex-valued signal,
wherein the IQ separator includes
a multiplication circuit to multiply, by a multiplier of −1, data of D-bits (where D is a positive integer greater than or equal to three) represented in the second representation format,
wherein the second representation format, while for a non-negative data value being identical to the two's complement representation therefor, for a negative data value, has a representation format in which (D−N−1) bits (where N is a positive integer such that N≤D−2) represented in the two's complement representation are bit-wise inverted, wherein the (D−N−1) bits are bits obtained by excluding, from the data of D-bits, a most significant bit indicating a sign and N consecutive lower bits including a least significant bit, and
wherein the multiplication circuit of the IQ separator, as multiplication by the multiplier of −1, bit-inverts the most significant bit indicating the sign and multiplies the N consecutive lower bits including the least significant bit (where N is a positive integer such that N≤D−2) by −1 for the data represented in the second representation format.

3. The signal processing apparatus according to claim 2, wherein the IQ separator is configured to:
obtain a complex conjugate signal of the first complex-valued signal, while kept in the second representation format by performing the multiplication process by the multiplier of −1 on data of an imaginary part of the first complex-valued signal represented in the second representation format;
convert data of a real part and an imaginary part of the complex conjugate signal represented in the second representation format to the two's complement representation; and
separate the first complex-valued signal represented in the second representation format into the second complex-valued signal and the third complex-valued signal represented in the two's complement representation for output.

4. The signal processing apparatus according to claim 2, comprising
an output part configured to:
receive the sixth complex-valued signal in frequency domain represented in the two's complement representation outputted from the IQ combiner; and
apply inverse Fourier transform thereon to obtain the sixth complex-valued signal in time domain for output, as an output signal.

5. The signal processing apparatus according to claim 1, wherein the signal processing apparatus is configured to perform fast Fourier transform and/or inverse Fourier transform, wherein the storage processing part includes:
a data reordering processing part configured to rearrange an order of a plurality of pieces of data supplied in a first order to a second order,
wherein the data reordering processing part includes:
a storage circuit;
a first control part configured to write a plurality of pieces of data to the storage circuit in accordance with one of a first address order and a second address order; and
a second control part configured to read, from the storage circuit, the plurality of pieces of data that have been written to the storage circuit in accordance with the one of the first address order and the second address order, in accordance with other of the first address order and the second address order.

6. The signal processing apparatus according to claim 5, wherein in the storage processing part,
the storage circuit includes
a plurality of storage elements configured to store the plurality of pieces of data for each of a plurality of cycles,
wherein a plurality of addresses simultaneously supplied to the plurality of storage elements are different from each other in the first address order, and
a plurality of addresses simultaneously supplied to the plurality of storage elements are identical to each other in the second address order.

7. The signal processing apparatus according to claim 6, wherein the first operation processing part includes:
a butterfly operation processing part configured to perform butterfly operation processing on plurality of pieces of data represented in the two's complement representation; and
a twiddle factor multiplication processing part configured to perform twiddle factor multiplication processing on plurality of pieces of data represented in the two's complement representation,
wherein the storage processing part further includes:
a first conversion part configured to:
receive a plurality of pieces of data represented in the two's complement representation; and
convert the plurality of pieces of data represented in the two's complement representation received to a plurality of pieces of data represented in the second representation format for output; and
a first data distribution part configured to:
receive the plurality of pieces of data represented in the second representation format outputted from the first conversion part; and
perform data distribution processing on the plurality of pieces of data received,
wherein the plurality of pieces of data represented in the second representation format distributed by the first data distribution part are written to the plurality of storage elements using addresses outputted from the first control part, and
wherein the storage processing part further includes:
a second data distribution part configured to:
receive the plurality of pieces of data represented in the second representation format read from the plurality of storage elements using addresses outputted from the second control part; and
perform data distribution processing on the plurality of pieces of data received; and
a second conversion part configured to:
receive the plurality of pieces of data represented in the second representation format distributed by the second data distribution part; and
convert the plurality of pieces of data received and represented in the second representation format to a plurality of pieces of data represented in the two's complement representation for output.

8. The signal processing apparatus according to claim 1, comprising a multiplication circuit configured to receive the data of D-bits represented in the second representation format and multiply the data of D-bits represented in the second representation format by −1, wherein the multiplication circuit includes:
a sign inversion circuit configured to bit-invert the most significant bit indicating the sign of the data of D-bits represented in the second representation format; and
a −1 multiplication circuit configured to multiply the N consecutive lower bits including the least significant bit of the data of D-bits represented in the second representation format (where N is a positive integer such that N≤D−2) by −1.

9. The signal processing apparatus according to claim 8, comprising
a conversion circuit configured to receive the data of D-bits represented in one representation format out of the second representation format and the two's complement representation, and convert the data received to data represented in other representation format out of the second representation format and the two's complement representation for output,
wherein the conversion circuit includes a circuit configured to:
output a most significant bit of the data of D-bits received, as it is, as a most significant bit of the data of D-bits represented in the converted other representation format;
output N consecutive lower bits including a least significant bit of the data of D-bits received (where N is a positive integer such that N≤D−2), as they are, as the N consecutive lower bits including a least significant bit of the data of D-bits represented in the converted other representation format;
for (D−N−1) bits obtained by excluding the most significant bit and the N consecutive lower bits including the least significant bit of the data of D-bits received,
when a sign indicated by the most significant bit of the data of D-bits received indicates a negative value,
output values obtained by bit-wise inverting each of the (D−N−1) bits of the data of D-bits received as the (D−N−1) bits obtained by excluding the most significant bit and the N consecutive lower bits including the least significant bit of the data of D-bits represented in the converted other representation format; and
when the sign indicated by the most significant bit of the data of D-bits received indicates a non-negative value,
output the (D−N−1) bits of the data of D-bits received, as they are, as the (D−N−1) bits obtained by excluding the most significant bit and the N consecutive lower bits including the least significant bit of the data of D-bits represented in the converted other representation format.

10. A signal processing method comprising
processing signal data represented in a second representation format as a data representation format, wherein the signal data is data of D-bits (where D is a positive integer greater than or equal to three),
wherein the second representation format, while for a non-negative data value being identical to a two's complement representation therefor, for a negative data value, has a representation format in which (D−N−1) bits (where N is a positive integer such that N≤D−2) represented in the two's complement representation are bit-wise inverted, wherein the (D−N−1) bits are bits obtained by excluding, from the data of D-bits, a most significant bit indicating a sign and N consecutive lower bits including a least significant bit, and
wherein the N consecutive lower bits including the least significant bit represented in the second representation format are identical to the N consecutive lower bits including the least significant bit represented in the two's complement representation,
the signal processing method comprising:
receiving the data of D-bits represented in the second representation format and multiplying the data by −1,
bit-inverting the most significant bit indicating the sign of the data represented in the second representation format; and
multiplying the N consecutive lower bits including the least significant bit of the data represented in the second representation format by −1.

11. The signal processing method according to claim 10, comprising
receiving the data of D-bits represented in one representation format out of the second representation format and the two's complement representation and converting the data received to data represented in other representation format out of the second representation format and the two's complement representation for output,
wherein the converting the data includes:
outputting a most significant bit of the data of D-bits received, as it is, as a most significant bit of the data of D-bits represented in the converted other representation format;
outputting N consecutive lower bits including a least significant bit of the data of D-bits received (where N is a positive integer such that N≤D−2), as they are, as the N consecutive lower bits including a least significant bit of the data of D-bits represented in the converted other representation format;
for (D−N−1) bits obtained by excluding the most significant bit and the N consecutive lower bits including the least significant bit of the data of D-bits received,
when a sign indicated by the most significant bit of the data of D-bits received indicates a negative value,
outputting values obtained by bit-wise inverting each of the (D−N−1) bits of the data of D-bits received as the (D−N−1) bits obtained by excluding the most significant bit and the N consecutive lower bits including the least significant bit of the data of D-bits represented in the converted other representation format; and
when the sign indicated by the most significant bit of the data of D-bits received indicates a non-negative value,
outputting the (D−N−1) bits of the data of D-bits received, as they are, as the (D−N−1) bits obtained by excluding the most significant bit and the N consecutive lower bits including the least significant bit of the data of D-bits represented in the converted other representation format.
